(19) United States
(12) Patent Application Publication
(10) Pub. No.: US 2008/0290120 A1
(43) Pub. Date: Nov. 27, 2008

(54) Actuator cap for a spray device

(76) Inventors: Thomas A. Helf, New Berlin, WI (US); Edward L. Paas, Los Altos, CA (US)

Correspondence Address: S.C. JOHNSON & SON, INC., 1525 HOWE STREET, RACINE, WI, 53403-2236, US

(21) Appl. No.: 11/893,532

(22) Filed: Aug. 16, 2007

Related U.S. Application Data
(63) Continuation-in-part of application No. 11/805,976, filed on May 25, 2007.

(51) Int. Cl. B67D 3/00; G04C 23/42

(52) U.S. Cl. 222/649; 222/504

(57) ABSTRACT

An actuator cap for a container includes a housing having first and second ends, wherein the first end is adapted to be retained on a container having a valve stem. A conduit includes first and second ends, wherein an engagement member is provided within the conduit adjacent the second end thereof. The engagement member is adapted to prevent fluid discharge from a valve stem having a circular discharge orifice and allow fluid discharge from a valve stem having a non-circular discharge orifice. A solenoid valve is provided in fluid communication with the first end of the conduit and a discharge nozzle of the housing.

### CROSS REFERENCE TO RELATED APPLICATIONS

This application is a continuation-in-part of a U.S. patent application No. 11/805,976, filed May 25, 2007, entitled “Actuator Cap for a Spray Device”, docket number J-4777.

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Background

The present disclosure relates generally to discharging a fluid from a spray device, and more particularly, to an actuator for automatically and manually discharging a fluid from a pressurized aerosol container.

2. Description of the Background of the Invention

Discharge devices for automatically dispensing pressurized fluids from aerosol containers are typically provided with an actuator mechanism for engaging a nozzle of the aerosol container. A wide variety of products may be stored in the container such as an air freshener, a deodorizer, an insect repellant or insecticide, a hair care product, shaving cream, or the like. Some actuator mechanisms retain the nozzle of the aerosol container in an open position and regulate the emission of fluid through a separate valve in the device.

One example of such a device includes a housing with an inlet provided in a bottom wall thereof. The inlet is adapted to receive a vertically operative valve stem of a container and hold the valve stem in a depressed and open position to allow fluid discharge from the container. A solenoid valve having a spring biased plug is disposed adjacent the bottom wall. When the device is activated, the plug is moved laterally to provide a passage for the fluid to pass through an opening in a valve seat, into an outlet channel, and out of the housing through an outlet opening.

In a different example, a discharge device includes a housing adapted to hold an aerosol container. A solenoid valve is in communication with a discharge end of the container, which maintains a discharge valve of the container in an open position. A controller is electrically coupled to the solenoid valve to cause the periodic discharge of fluid through a discharge outlet thereof, which is aligned with a discharge orifice of the housing. A manual switch is also provided, which is electrically coupled to the controller to allow for the manual activation of the solenoid valve.

None of the prior art discloses a discharge device that includes a mechanism for preventing the use of the device when a non-specified container is disposed therein. Therefore, it may be desirable to have an engagement mechanism in combination with a discharge device that is specifically designed to discharge fluid contents from containers having specific types of valve stems. By preventing use of the discharge device with a container including a valve stem that is not specifically adapted for use with the discharge device damage to the device and/or container may be prevented.

### SUMMARY OF THE INVENTION

According to one embodiment, an actuator cap for a container includes a housing having first and second ends, wherein the first end is adapted to be retained on a container having a valve stem. A conduit includes first and second ends, wherein an engagement member is provided within the conduit adjacent the second end thereof. The engagement member is adapted to prevent fluid discharge from a valve stem having a circular discharge orifice and allow fluid discharge from a valve stem having a non-circular discharge orifice. A solenoid valve is provided in fluid communication with the first end of the conduit and a discharge nozzle of the housing.

In a different embodiment, an overcap for a container includes a housing having a bottom end and a top end, wherein the bottom end is adapted to be retained on a container having a valve stem. A conduit includes first and second ends, wherein an engagement member is provided within the conduit adjacent the second end thereof. The engagement member is adapted to prevent fluid discharge from a valve stem having a uniformly circular discharge orifice and allow fluid discharge from a valve stem having at least one side opening therethrough. A solenoid valve is provided in fluid communication with the first end of the conduit and a discharge nozzle of the housing.

In yet another embodiment, a method of preventing incorrect refill of a dispensing system is provided that includes the step of providing a housing having first and second ends, wherein the first end is adapted to be retained on a container having a valve stem. Another step includes providing a conduit having first and second ends, wherein an engagement member is provided within the conduit adjacent the second end thereof. The engagement member is adapted to prevent fluid discharge from a valve stem having a circular discharge orifice and allow fluid discharge from a valve stem having a non-circular discharge orifice. Yet another step includes providing a solenoid valve in fluid communication with the first end of the conduit and a discharge nozzle of the housing.

Other aspects and advantages of the present invention will become apparent upon consideration of the following detailed description.

### BRIEF DESCRIPTION OF THE DRAWINGS

FIG. 1 is an isometric view of a front side, a left side, and a top side of a first embodiment of an overcap;

FIG. 2 is a front isometric view of the overcap of FIG. 1;

FIG. 3 is a rear elevational view of the overcap of FIG. 1;

FIG. 4 is a left side elevational view of the overcap of FIG. 1;

FIG. 5 is a right side elevational view of the overcap of FIG. 1;

FIG. 6 is a top plan view of the overcap of FIG. 1;

FIG. 7 is a bottom elevational view of the overcap of FIG. 1;

FIG. 8 is a rear exploded isometric view of a body, a platform, and a top end of the overcap of FIG. 1;

FIG. 9 is a front exploded isometric view of a body, a platform, and a top end of the overcap of FIG. 1;

FIG. 10 is an enlarged isometric view of the platform of FIGS. 8 and 9;

FIG. 11 is a partial sectional view taken along section 11-11 of the overcap of FIG. 1, which includes one embodiment of a bracket for mounting the overcap on a container;

FIG. 12 is an isometric view illustrating the overcap of FIG. 1 on a container;

FIG. 13 is an isometric view of the bracket of FIG. 11 mounted on a container;

FIG. 14 is an isometric view of the bracket of FIG. 13 removed from the container;

FIG. 15 is a front elevational view of the bracket of FIG. 14;

FIG. 16 is a top plan view of the bracket of FIG. 14;

FIG. 17 is a bottom elevational view of the bracket of FIG. 14;

FIG. 18 illustrates another isometric view of an overcap similar to the one depicted in FIG. 12, which includes an A.C. connector;

FIG. 19 is an isometric view of the overcap of FIG. 1 mounted on a container that further illustrates several triggers on various portions of the overcap;

FIG. 20 is a timing diagram illustrating the operation of the overcap of FIGS. 1-11 according to a first operational sequence;

FIG. 21 is an isometric view of another embodiment of the overcap of FIG. 1 with portions of the overcap removed to show a frangible tab affixed to a lug on an inside portion of the overcap;

FIG. 22 is an isometric view of the bracket of FIG. 14 in combination with the lug of the overcap of FIG. 21, wherein the overcap has been removed for purposes of clarity;

FIG. 23 is an isometric view of the bracket of FIG. 22 showing the lug in a second position after the frangible tab has been broken;

FIG. 24 is an isometric view of the bracket of FIG. 22 illustrating the lug in a third position;

FIG. 25 is an isometric view of the bracket of FIG. 22 illustrating the lug in a fourth position;

FIG. 26 is a schematic front elevational, partial sectional view of another embodiment of an overcap;

FIG. 27 is a view similar to the one shown in FIG. 11, except that the overcap is mounted on a container and a valve stem of the container and a conduit of the overcap are shown in section;

FIG. 28 is an enlarged, partial isometric view of the conduit and the valve stem depicted in FIG. 27;

FIG. 29 is a front elevational view of the conduit and the valve stem of FIG. 28;

FIG. 30 is an enlarged isometric view of a different valve stem;

FIG. 31 is a view of a different embodiment of the conduit and the valve stem depicted in FIG. 29, wherein the conduit has been modified and the valve stem replaced by the valve stem shown in FIG. 30;

FIG. 32 is a fragmentary diagrammatic view of another embodiment of a valve stem disposed adjacent an actuating element;

FIG. 33 is a view similar to FIG. 32 of another embodiment of an actuating element adjacent a valve stem;

FIG. 34 is a sectional view taken generally along the lines 34-34 of FIG. 33 with the actuating element in engagement with the valve stem; and

FIGS. 35-43 are enlarged isometric views of alternative valve stems that may be used in conjunction with the embodiments described herein.

### DETAILED DESCRIPTION OF THE DRAWINGS

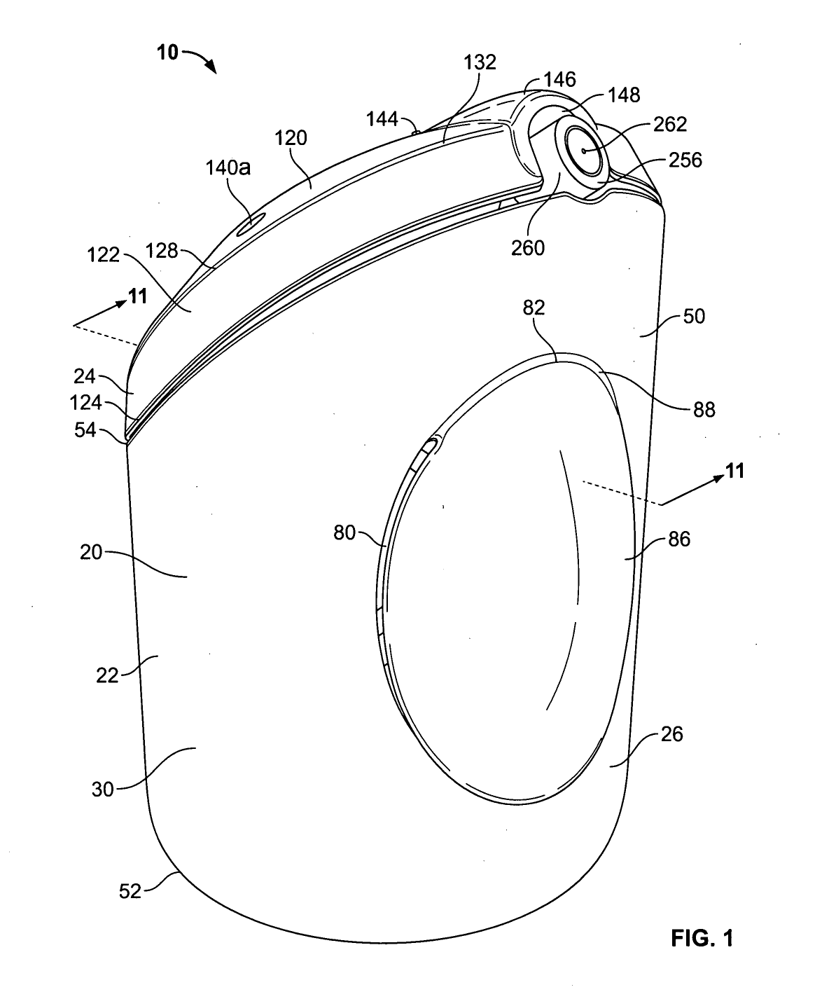

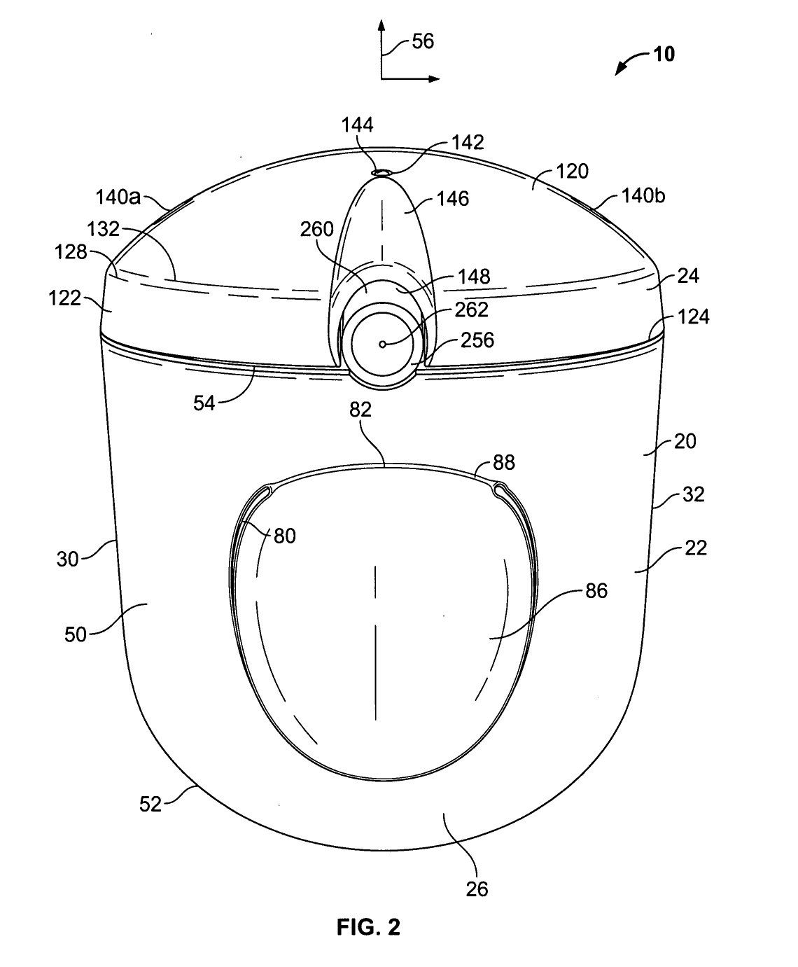

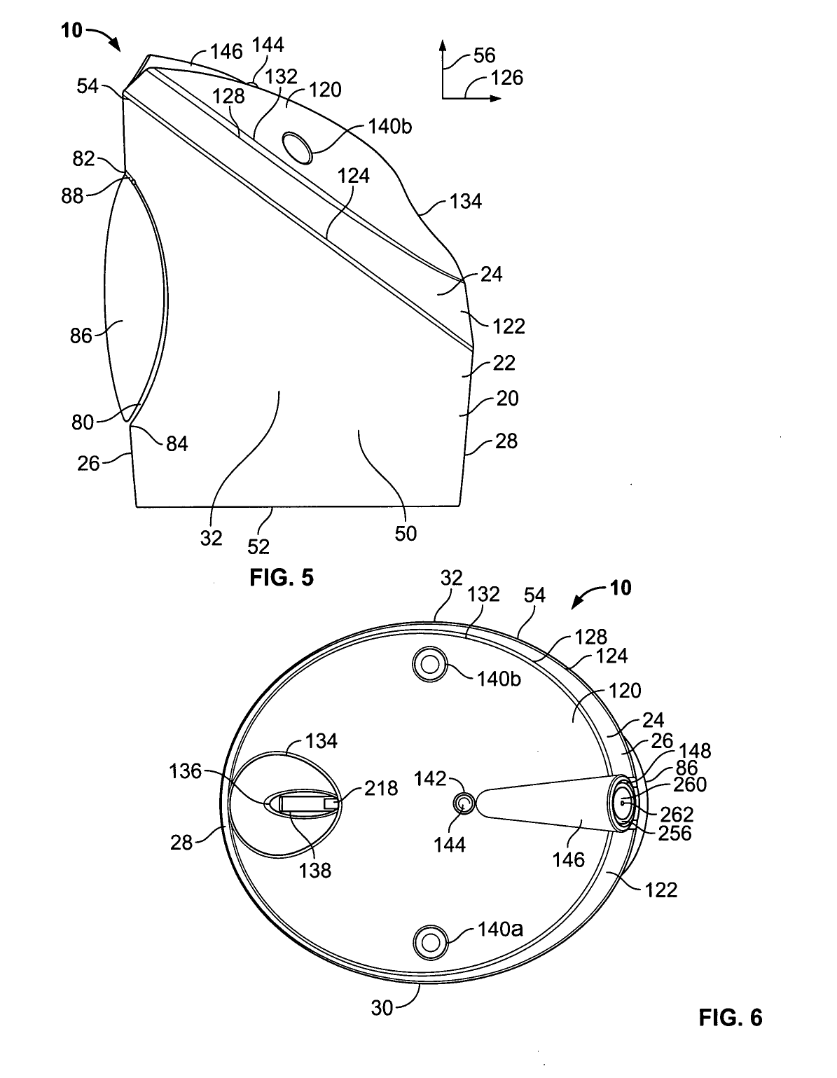

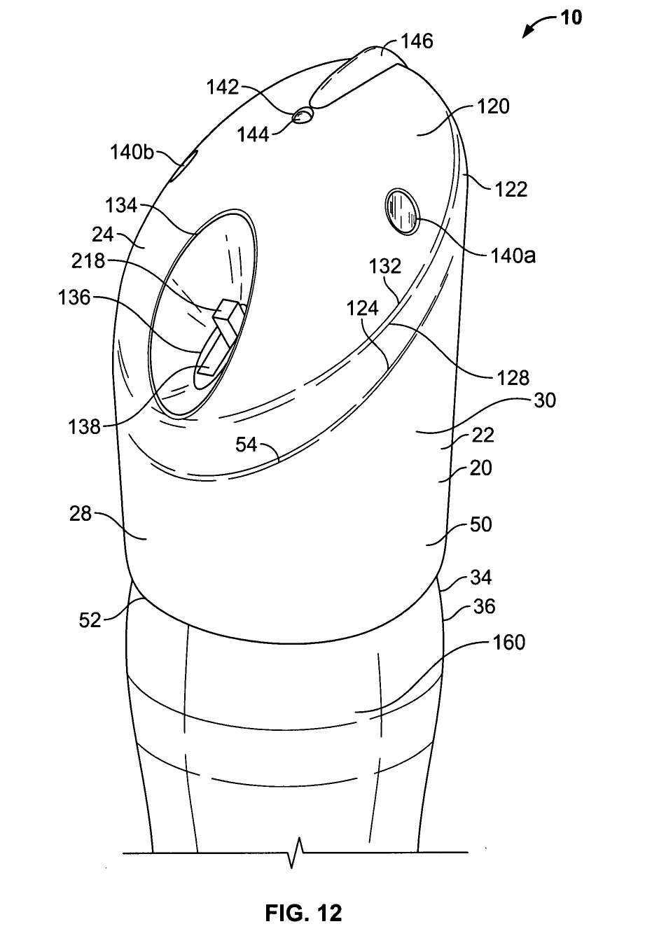

FIGS. 1-11 depict an actuator overcap 10 having a housing 20. The housing 20 includes a body portion 22 and a cap portion 24 disposed on a top end thereof. The housing 20 is also generally delineated by a front side 26, a rear side 28, and opposing left and right sides 30, 32, respectively. The overcap 10 is adapted to be retained on an upper end 34 of an aerosol container 36, which is shown in FIG. 12 and will be described in further detail below. The overcap 10 provides a user the ability to automatically or manually dispense fluid from the container 36. It is intended that the overcap 10 be used in many diverse environments, such as a home, a business, a vehicle, outdoors, etc.

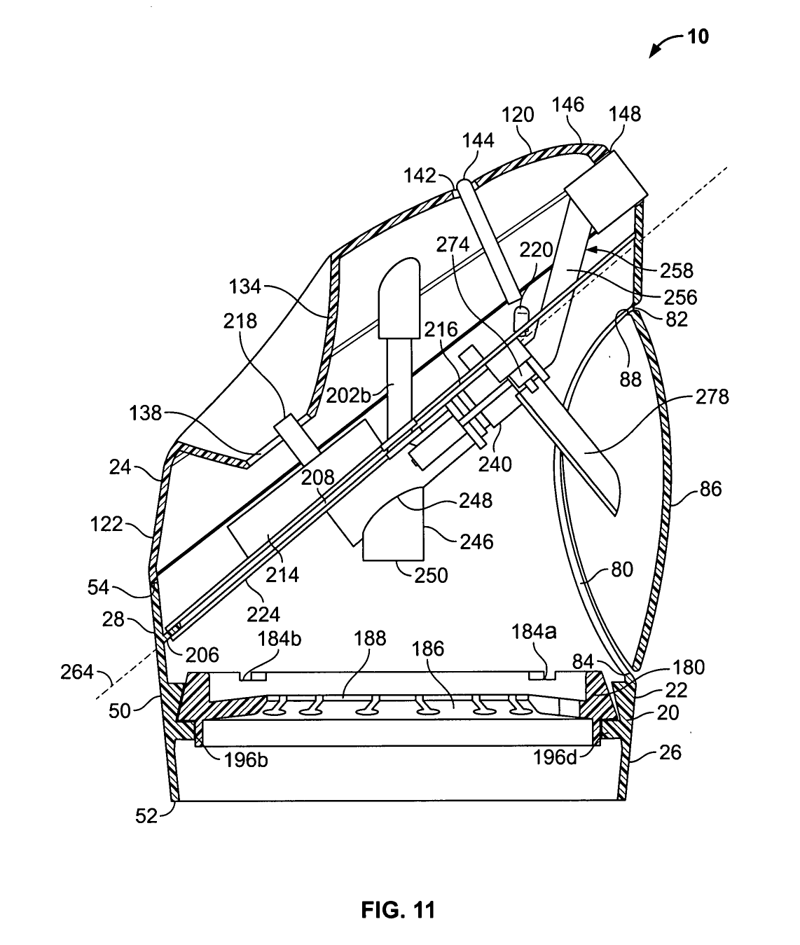

The body portion 22 includes a sidewall 50 and is adapted to be gripped by a user's hand. The sidewall 50 extends from a lower end 52 of the body portion 22 to an upper end 54 thereof. The sidewall 50 tapers outwardly about a longitudinal axis 56 of the overcap 10 so that a cross-sectional diameter of the lower end 52 is smaller than a cross-sectional diameter of the upper end 54. The front side 36 of the sidewall 50 includes an oval-shaped recess 80. The recess 80 includes a major diameter that extends between first and second ends 82, 84 (see FIG. 11), which are adjacent the upper and lower ends 54, 52, respectively, of the sidewall 50. An oval-shaped flange 86 that is sized to be substantially co-extensive with the recess 80 is provided therein. The flange 86 is connected to the sidewall 50 by a resilient living hinge 88 adjacent the first end 82 of the recess 80. The thickness of the living hinge 88 is less than the thickness of the remaining sides of the sidewall 50 to impart flexibility and resiliency to the living hinge 88.

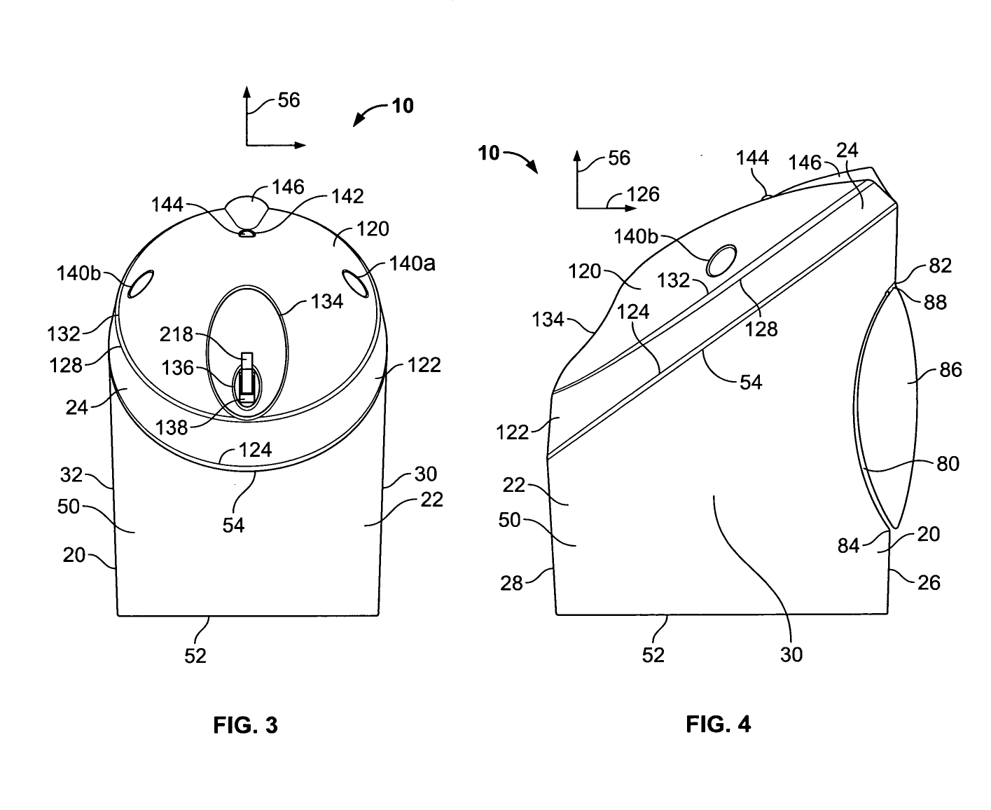

The cap portion 24 comprises a shell 120 and an annular rim 122. A lower end 124 of the annular rim 122 is disposed on the upper end 54 of the sidewall 50 and truncates same at approximately a 45 degree angle relative to a transverse axis 126 of the overcap 10. The shell 120 extends from an upper end 128 of the rim 122 and has a generally convex surface. The convex surface of the shell 120 is bounded by an elliptical shaped edge 132 that extends circumferentially around the upper end 128 of the annular rim 122. As shown in FIGS. 3-6, 8, and 11, a curved cavity 134 is disposed within the shell 120 adjacent the rear side 28 of the overcap 10. The curved cavity 134 includes a flat bottom 136 with a rectangular slot 138 disposed therein. Two holes 140a, 140b are disposed on opposing sides of the transverse axis 126 adjacent the left and right sides 30, 32, respectively, of the overcap 10. An aperture 142 is also provided between the cavity 134 and the front side 26 of the overcap 10. A light transmissive rod 144 is held within the aperture 142 by an interference fit (see FIG. 11). A curved ridge 146 extends from the aperture 142 toward the front side 26 of the overcap 10. An opening 148 is provided within portions of the ridge 146, the annular rim 122, and the sidewall 50 adjacent the front side 26 of the overcap 10.

The overcap 10 discharges fluid from the container 36 upon the occurrence of a particular condition. The condition could be the manual actuation of the overcap 10 by the flange 86 or the automatic actuation of the overcap 10 in response to a signal from a timer or a sensor. The fluid discharged may be a fragrance or insecticide disposed within a carrier liquid, a deodorizing liquid, or the like. The fluid may also comprise other actives, such as sanitizers, air fresheners, odor eliminators, mold or mildew inhibitors, insect repellents, and the like, or that have aromatherapeutic properties. The fluid alternatively comprises any fluid known to those skilled in the art that can be dispensed from a container. The overcap 10 is therefore adapted to dispense any number of different fluid formulations.

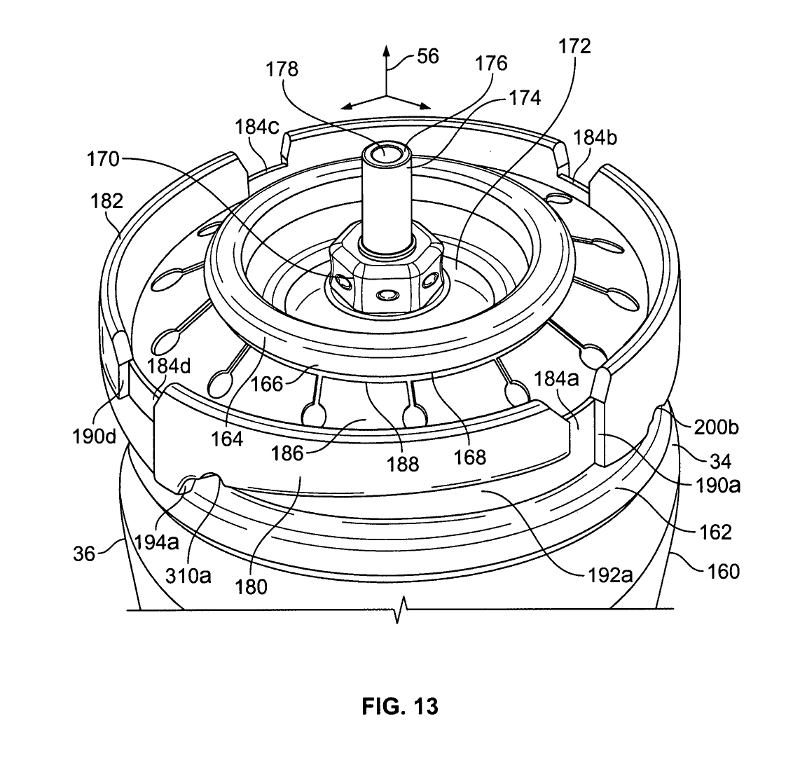

Turning to FIG. 13, the aerosol container 36 comprises a body 160 having a dome shaped wall section 162 crimped to the upper end 34 of the container 36. An opening (not shown) is provided within an upper end of the wall section 162 and is obstructed by a mounting cup 164, which is similarly crimped to the wall section 162. The mounting cup 164 is generally cylindrical in shape and includes an outer wall 166 that extends circumferentially therearound. An undercut 168 is provided between portions of the container 36 and the area of crimping of the mounting cup 164. A pedestal 170 extends upwardly from a recessed central portion of a base 172 of the mounting cup 164. A valve assembly (not shown) provided in an interior of the container 36 includes a valve stem 174, a valve body (not shown), and a valve spring (not shown). The valve stem 174 extends through the pedestal 170, wherein a distal end 176 extends upwardly away from the pedestal 170 and a proximal end is disposed within the valve body. The valve assembly is opened by depressing the valve stem 174, wherein a pressure differential between the container interior and the atmosphere forces the contents of the container 36 out through an orifice 178 of the valve stem 174. While the present disclosure describes the applicants' invention with respect to the aerosol container 36, the present invention may be practiced with any type of aerosol container known to those skilled in the art. Further, the contents of the container 36 may be discharged in a continuous or metered dose. Still further, the discharging of the contents of the container 36 may be effected in any number of ways, e.g., a discharge may comprise a partial metered dose or multiple consecutive discharges.

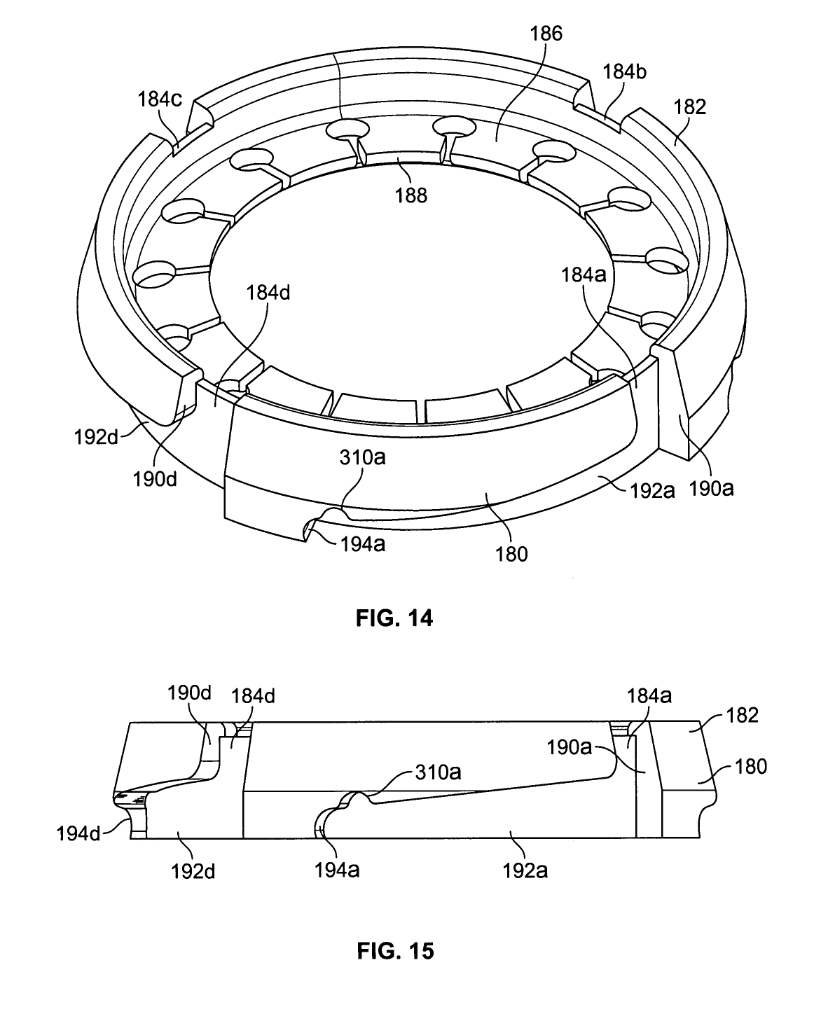

As noted above, the overcap 10 is adapted to be retained on the upper end 34 of the container 36. Turning to FIGS. 11 and 13-17 one such retaining structure is shown to comprise an annular bracket 180. The bracket 180 includes a circumferential sidewall 182 interrupted by equidistantly spaced bayonet slots 184a, 184b, 184c, 184d. The bracket 180 also includes a plurality of resilient flanges 186 that extend radially inwardly from a medial portion of the sidewall 182 toward the mounting cup 164. Distal ends 188 of the plurality of flanges 186 are sized to bend about the outer wall 166 of the mounting cup 164 when the bracket 180 is pressed downwardly onto the upper end 34 of the container 36. Sufficient downward force causes the distal ends 188 of the plurality of flanges 186 to snap into the undercut 168, thereby retaining the bracket 180 on the container 36. The bayonet slots 184a, 184b, 184c, 184d include grooves 190a, 190b, 190c, 190d, respectively, that extend through an outer surface of the sidewall 182. Further, channels 192a, 192b, 192c, 192d, extend circumferentially about a lower portion of the sidewall 182 from the grooves 190a, 190b, 190c, 190d, respectively. A depth of the channels 192a-d becomes uniformly shallower as the channels 192a-d extend from the grooves 190a-d to distal ends 194a, 194b, 194c, 194d of the channels 192a, 192b, 192c, 192d, respectively.

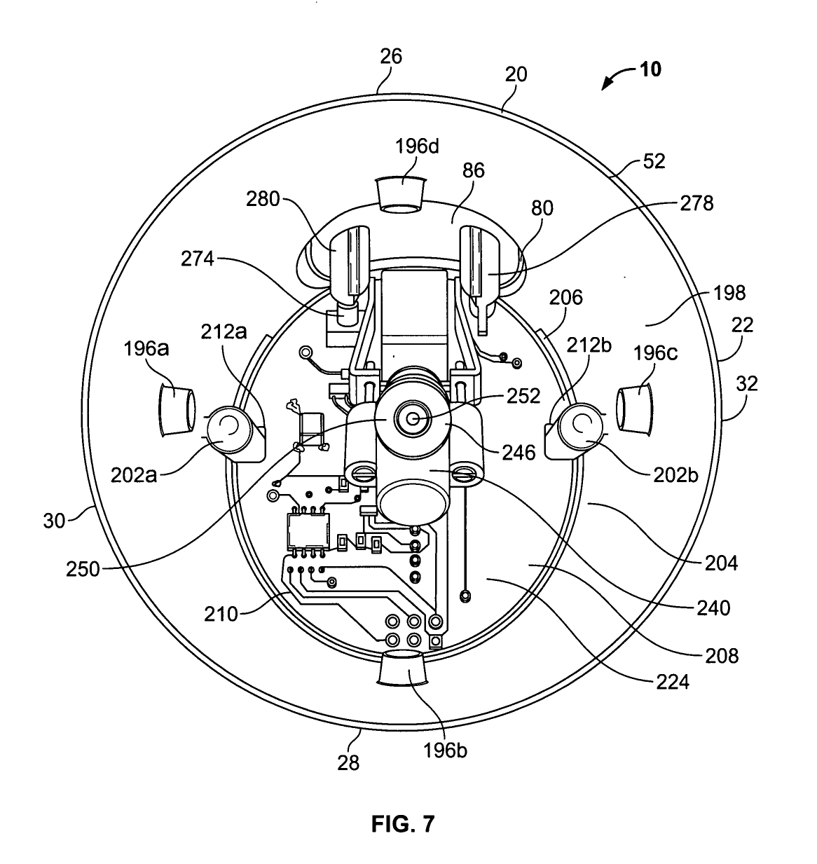

To operably place the overcap 10 onto the container 36, a user must align lugs 196a, 196b, 196c, 196d, which are shown in FIGS. 7 and 11, with the bayonet slots 184a, 184b, 184c, 184d, respectively. The lugs 196a-d are equidistantly spaced apart on an inner surface 198 of the body portion 22 and are sized to be received within the grooves 190a-d of the bayonet slots 184a-d. Upon receipt of the lugs 196a-d within the grooves 190a-d, a user rotates the overcap 10 in a clockwise manner to slide the lugs 196a-d into the channels 192a-d. Continued rotational movement of the overcap 10 forces the lugs 196a-d to impinge against the walls defining the channels 192a-d and force them downwardly as the depth of the channels 192a-d becomes shallower. Forcing the lugs 196a-d downwardly also forces the overcap 10 itself to be pulled downwardly toward the container 36. The lugs 196a-d are thereafter releaseably locked in place at the distal ends 194a-d of the channels 192a-d, which will be described in greater detail hereinafter, to retain the overcap 10 onto the container 36 in an operable position.

It is also contemplated that modifications may be made to the bracket 180. For example, a fewer or greater number of flanges may be provided to interact with surfaces of a container. The flanges of the bracket may be resilient or rigid depending upon the contour of the outer surface of the container. Further, the overcap may be operably placed onto the bracket in a fixed or removable manner. Still further, the overcap may be operably placed on the container by other means besides those described above. In one embodiment, the overcap is threaded onto the bracket. In a different embodiment, one or more tabs are provided on the overcap or bracket for interaction with one or more recesses on the bracket or overcap, respectively. In another embodiment, portions of the overcap are inserted into the bracket and rotated to secure the portions of the overcap within a channel or between other locking surfaces of the bracket. It is also contemplated that any of these embodiments may be modified to include a structure for locking with the overcap on an interior, medial portion, or exterior of the bracket.

FIGS. 7, 8, and 11 illustrate that a pair of posts 202a, 202b are disposed on left and rights sides, respectively, of the inner surface 198 of the sidewall 50. Further, a ridge 206 extends circumferentially about a portion of the inner surface 198, which is adapted to support a platform 208. The platform 208 of the present embodiment, which is shown in FIGS. 7-11, is a printed circuit board having a control circuit 210 disposed thereon. In other embodiments, the control circuit 210 is a separate component from the platform 208 and is mounted on the platform 208 or otherwise retained within the interior of the overcap 10. The platform 208 is provided with notches 212a, 212b on opposing sides thereof corresponding to the posts 202a, 202b, respectively. When the platform 208 is secured within the overcap 10, the platform 208 is substantially parallel to the annular rim 122. A user selectable switch assembly 214 is disposed on an upper surface 216 of the platform 208 proximate the rear side 28 of the overcap 10. A finger 218 extends upwardly from the switch assembly 214. Further, a light emitting diode (LED) 220 is disposed on the platform 208 between the switch assembly 214 and a third notch 222. When the cap portion 24 is attached to the body portion 22, the posts 202a, 202b within the overcap 10 are aligned with the holes 140a, 140b of the convex surface of the shell 120. Screws (not shown) extend through the holes 140a, 140b and into the posts 202a, 202b, respectively, to attach the cap portion 24 to the body portion 22. When the cap portion 24 is attached to the body portion 22 the finger 218 extends through the slot 136, thereby allowing the user to select different operating modes for the circuit 210, which will be discussed in greater detail below.

FIGS. 7 and 9-11 depict a lower surface 224 of the platform 208, which includes a valve assembly 240 mounted thereon. The valve assembly 240 of the present embodiment comprises a two-way solenoid valve. The two-way solenoid valve of the present embodiment is a Tri-Tech Miniature Two Way Valve manufactured by Tri-Tech, LLC, of Mishawaka, Ind. However, other two-way solenoid valves known to those skilled in the art are also contemplated as being within the scope of the present disclosure. While a solenoid valve is presently described in connection with the disclosed embodiments, it is also contemplated that other mechanical and/or electrically controlled valve mechanisms known to those skilled in the art may be used.

A conduit 246 includes first and second ends 248, 250, respectively, and is in fluid communication with the solenoid valve assembly 240. The second end 250 is adapted to be disposed on the distal end 176 of the valve stem 174. More particularly, when the overcap 10 is first placed on the container 36 in the manner discussed above, the lugs 196a-d are aligned with the bayonet slots 184a-d. This alignment procedure also ensures that the valve stem 174 is aligned with the conduit 246. As the user rotates the overcap 10 and forces the lugs 196a-d into the channels 192a-d, the overcap 10 is pulled downwardly a sufficient distance to cause the second end 250 of the conduit 246 to impinge against the distal end 176 of the valve stem 174 and open the valve assembly of the container 36. When the distal end 176 of the valve stem 174 is pressed against the second end 250 of the conduit 246, a fluid path is provided between the discharge orifice 178 (see FIG. 13) of the valve stem 174 and a channel 252 (see FIG. 7) of the conduit 246. The spacing between the valve stem 174 and the conduit 246 is controlled to ensure full and/or partial depression of the valve stem 174 when the overcap 10 is placed onto the container 36 and into an operable position. Further, the spacing and sizing of the valve stem 174 and the conduit 246 is appropriately controlled to ensure fluid communication between the container 36 and the conduit 246 while preventing or substantially preventing fluid leakage between the point of contact of the distal end 176 of the valve stem 174 and the second end 250 of the conduit 246.

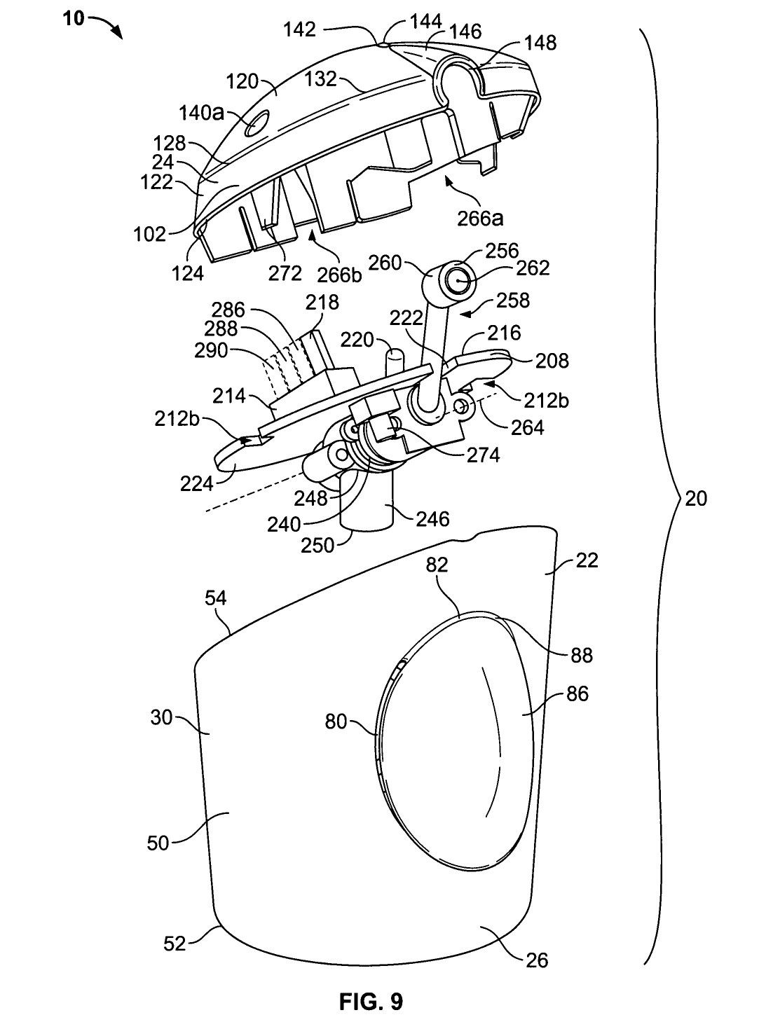

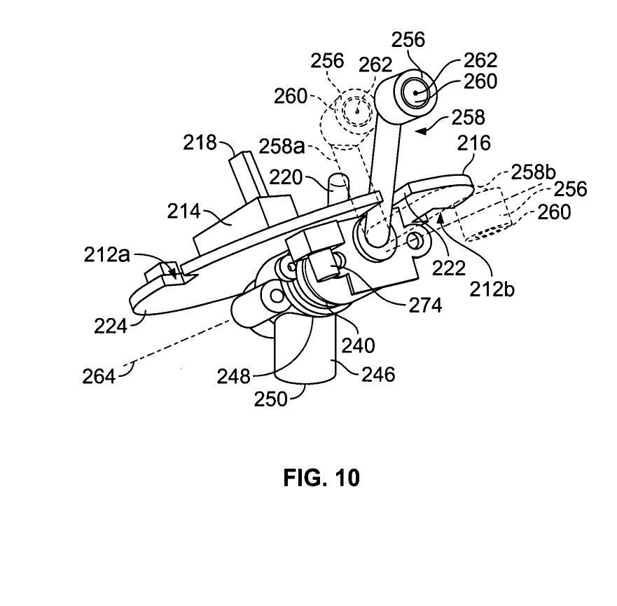

Referring again to FIGS. 7 and 9-11, the solenoid valve assembly 240 is in fluid communication with the first end 248 of the conduit 246. As noted above, when the overcap 10 is placed on the container 36 the valve assembly thereof is kept in an open state. Therefore, fluid is discharged through the valve stem 174 and into the conduit 246. The solenoid valve assembly 240 receives fluid from the conduit 246 and regulates the emission of the fluid therefrom by way of the control circuit 210. When the solenoid valve assembly 240 receives a signal from one or more of an elapsed timer, sensory input, or manual actuation of a trigger such as the flange 86, the solenoid valve assembly 240 is opened for a predetermined period of time. Fluid discharged from the solenoid valve assembly 240 is emitted through a nozzle 256. In the present embodiment, the nozzle 256 is disposed in a first position 258 (see FIGS. 9-11) at an angle relative to the longitudinal axis 56 of the container 36. Further, a discharge end 260 of the nozzle 256 is provided to direct the fluid out of the overcap 10 and into the atmosphere. In the present embodiment, the discharge end 260 includes a discharge orifice 262 and is retained within the opening 148 in the front side 36 of the overcap 10. Further, in the present embodiment, the discharge end 260 of the nozzle 256 is substantially parallel to a longitudinal axis 264 of the solenoid valve assembly 240. It is also contemplated that the nozzle 256 and/or the discharge end 260 may be oriented at any angle relative to the longitudinal axis 56, the transverse axis 126, the longitudinal axis 264, or any other axis of the overcap 10 or the solenoid valve assembly 240, of which the first, second, and third positions 258, 258a, 258b, respectively, shown in FIG. 10 are three examples.

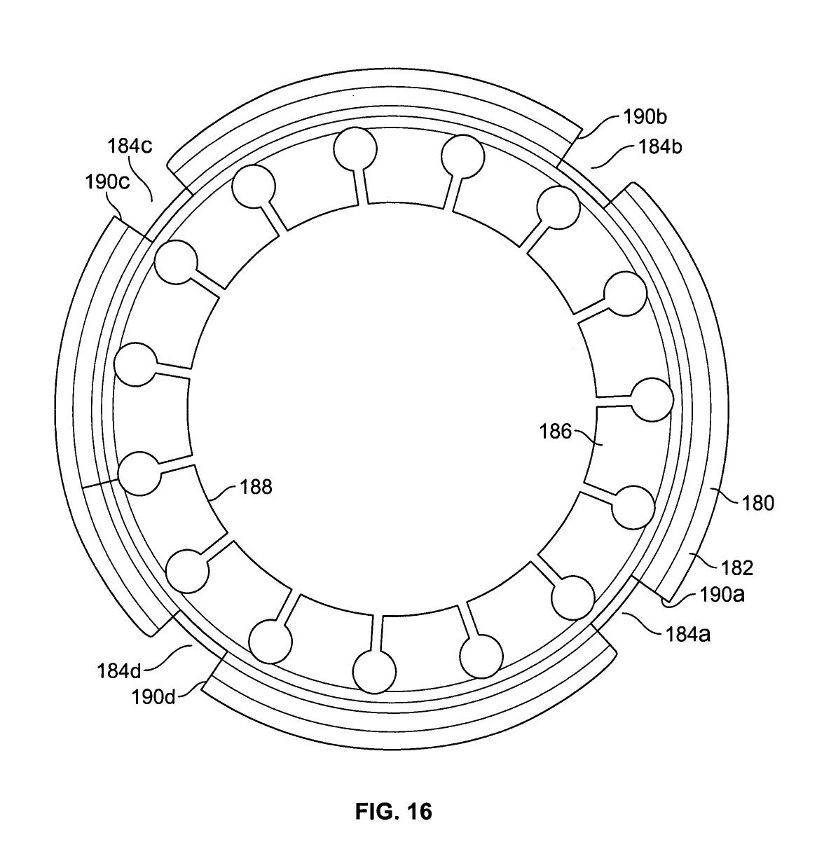

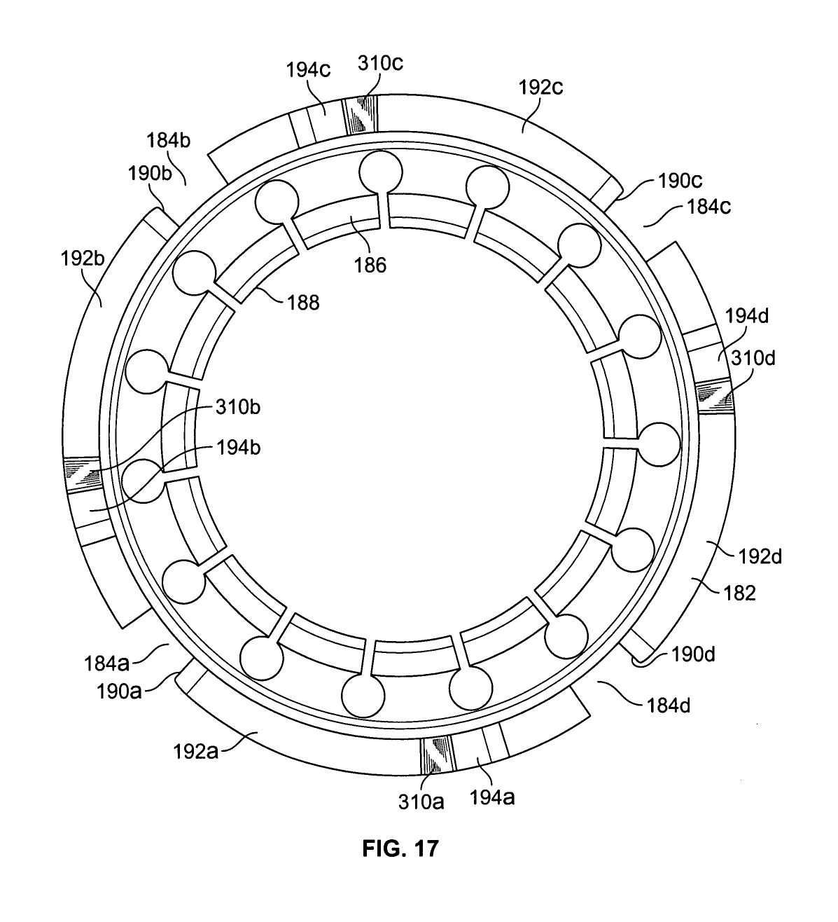

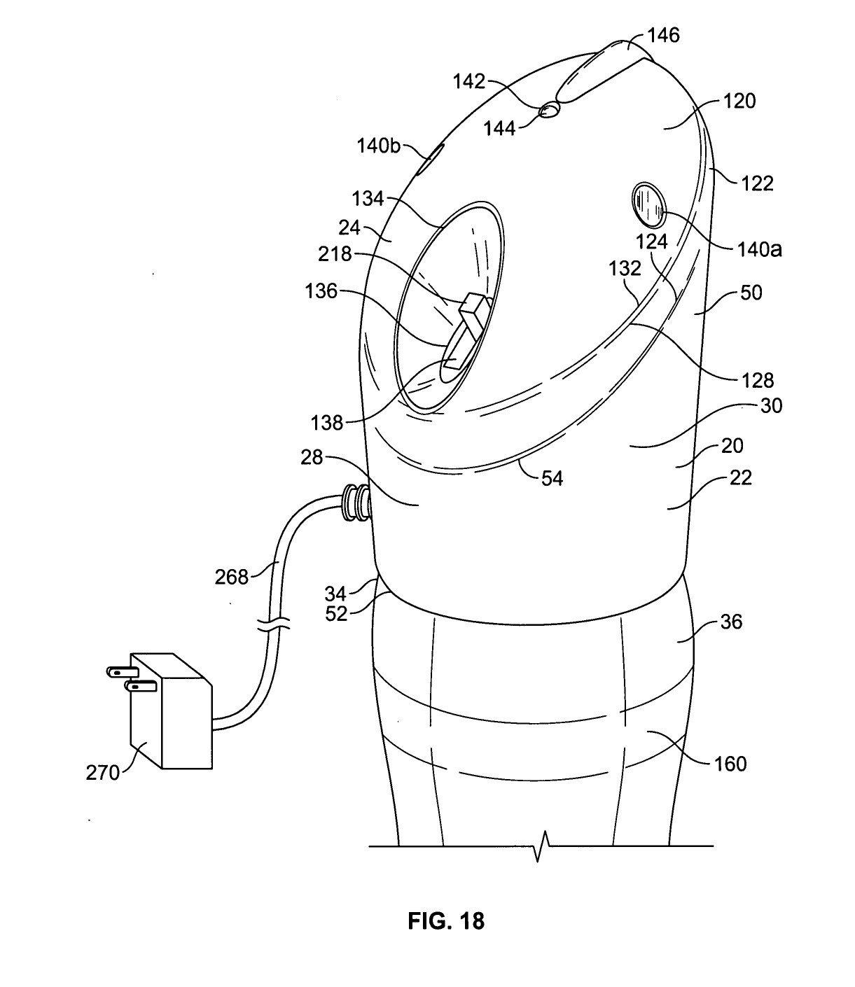

Turning to FIG. 9, first and second compartments 266a, 266b are provided on an inside surface of the cap portion 24. Both of the compartments 266a, 266b include positive and negative battery terminals therein (not shown). Further, each of the compartments 266a, 266b is adapted to fittingly receive two AA sized batteries therein. In an alternative embodiment, such as shown in FIG. 18, the AA batteries are replaced by an A.C power adapter 268 having an appropriate power transformer and A.C./D.C. converter 270 as known to those skilled in the art. In a different embodiment, the AA batteries are replaced by a rechargeable Nickel-Cadmium battery pack that has an electrical lead for connecting the battery pack to an A.C. power outlet. It is further contemplated that the overcaps described herein may be activated without a power source, i.e., interior portions of the flange 86 may be adapted to physically open the solenoid valve assembly to dispense fluid either continuously or intermittently when the flange 86 is depressed by a user. FIG. 9 also illustrates that the cap portion 24 includes a plurality of resilient members 272, which depend downwardly beyond the lower end 124 of the annular rim 122. The plurality of resilient members 272 are adapted to lockingly engage with an inside surface of the upper end 54 of the sidewall 50.

FIGS. 7 and 9-11 illustrate that a manual switch 274 is also provided on the lower surface 224 of the platform 208. The switch 274 (see FIG. 7) is positioned in alignment with an actuating arm 276 that extends from an inner surface of the flange 86. When the flange 86 is depressed by a user, the actuating arm 276 is pivoted about the living hinge 88 to impinge against the switch 274. When a user releases the flange 86, the actuating arm 276 rotates along with the flange 86 back into a pre-operative position where the arm 276 no longer impacts the switch 274 or, alternatively, no longer impacts the switch 274 to a degree sufficient to activate the overcap 10. A second arm 278 is also provided on the inner surface of the flange 86, which is adapted to stabilize the flange 86 when in a depressed or operative position. Utilization of a living hinge provides the user an easy means to manually actuate the overcap 10.

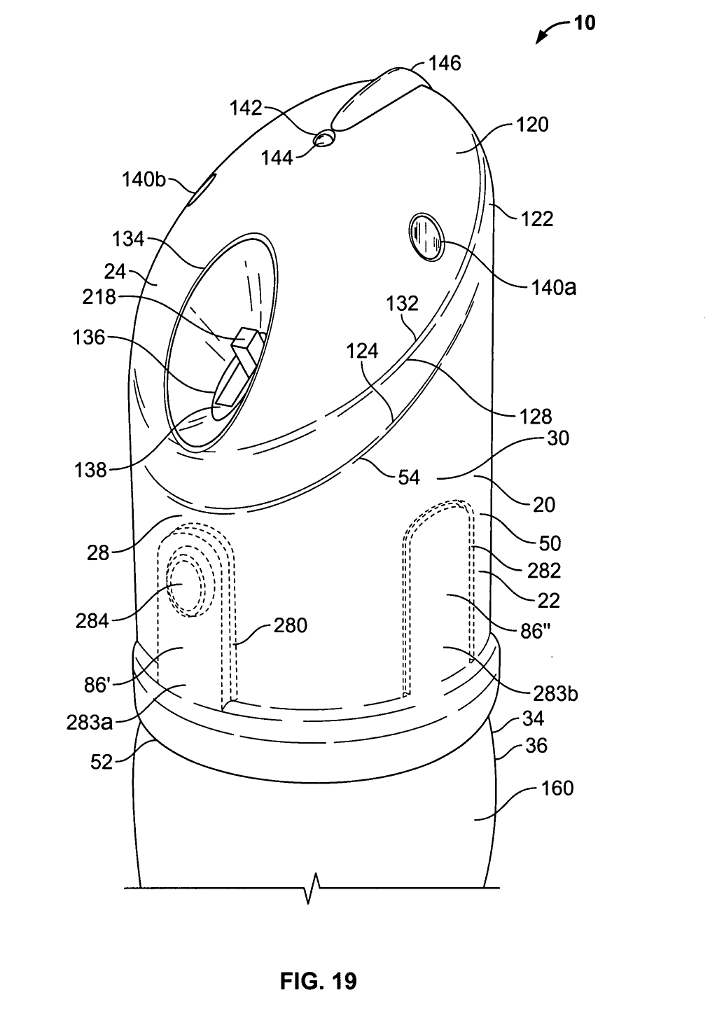

It is contemplated that other buttons and/or triggers may be used with the present embodiments that are similar in function to the flange 86, i.e., a button or trigger that includes a living hinge. FIG. 19 illustrates how the overcap 10 may be modified to include various buttons and/or triggers with different shapes and/or orientations. In the present embodiment, a stepped annular portion is provided adjacent the lower end 52 of the body portion 22. One example of a generally rectangular trigger 86′ extends upwardly from the stepped portion adjacent a recess 280 in the rear side 28 of the body portion 22. In another example, a generally rectangular button 86″ extends upwardly within a recess 282 in the left side 30 of the overcap 10 in a manner that is coextensive with the body portion 22. The trigger 86′ and the button 86″ of the present embodiments are adapted to flex about lower ends 283a, 283b, respectively, thereof, which may or may not be provided with weakened or thinned sections to assist in the flexure. The trigger 86′ and the button 86″ are illustrative of the various shapes and positions that triggers and/or buttons may have. Indeed, a button or actuator may be positioned anywhere about the overcap 10. Further, a button or trigger may also include surfaces adapted to assist in positioning a user's finger over a specified area of the button or trigger to assist in actuating same. For example, the trigger 86′ includes an outwardly extending portion 284 that has a concave depression adapted to receive a user's finger. In all of the embodiments, an inner surface (not shown) of the trigger 86′ or the button 86″ is adapted to impact and activate a switch (not shown) for the manual operation of the overcap 10. The activation of the switch may be made either directly or through other means such as an actuating arm (not shown) that may be similar to the actuating arm 276 described above. One advantage to using a trigger or button with a living hinge is that users may impart an actuating force over a greater surface area than typically found with conventional buttons. Further, the housings of the present embodiments may be fashioned to allow a user to easily grip the body portion 22 and to position one or more of the user's fingers adjacent the button or trigger. Still further, the trigger or button may be shaped or sized in any number of ways to provide certain aesthetic impressions.

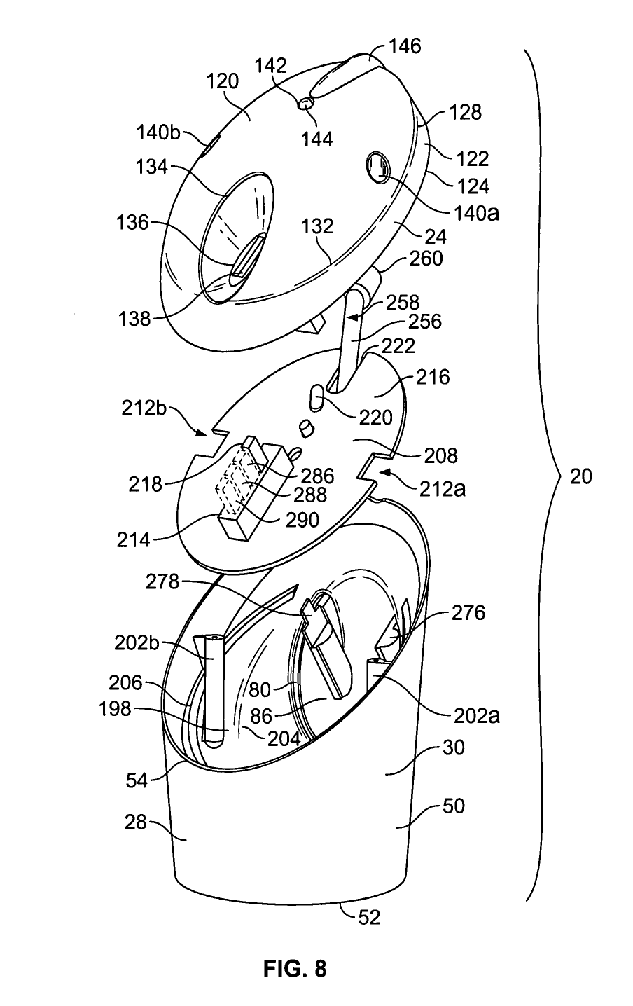

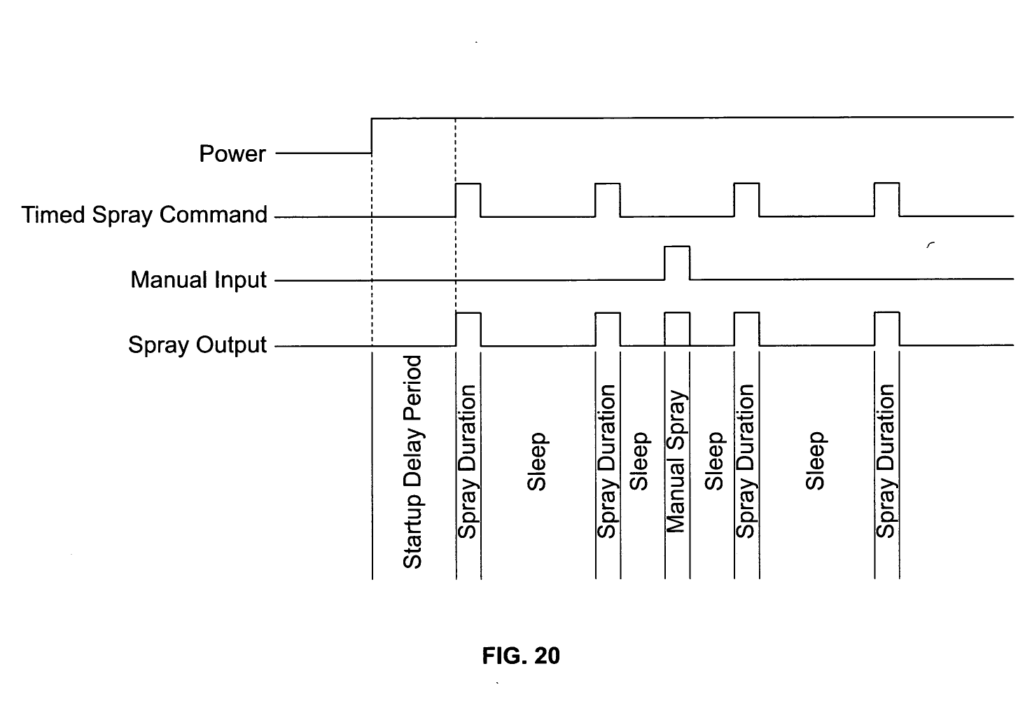

FIG. 20 depicts a timing diagram of the present embodiment that illustrates the operation of the overcap 10 during an in use condition. Initially, the overcap 10 is energized by moving the finger 218 of the switch assembly 214 from an “OFF” position to one of three operating modes 286, 288, 290 (see FIGS. 8 and 9), whereupon the overcap 10 enters a startup delay period. Each of the three operating modes 286, 288, 290 corresponds to a predetermined sleep period interval between consecutive spraying periods. For example, the first operating mode 286 can correspond to a five minute sleep period, the second operating mode 288 can correspond to a fifteen minute sleep period, and the third operating mode 290 can correspond to a thirty minute sleep period. For the present example, we shall assume the first operating mode 286 has been chosen. Upon completion of the startup delay period, the solenoid valve assembly 240 is directed to discharge fluid from the overcap 10 during a first spraying period. The startup delay period is preferably about three seconds long, and the spraying period is typically about 170 milliseconds long. Upon completion of the first spraying period, the overcap 10 enters a first sleep period that lasts 5 minutes. Upon expiration of the first sleep period the solenoid valve assembly 240 is actuated to discharge fluid during a second spraying period. Thereafter, the overcap 10 enters a second sleep period that lasts for 5 minutes. In the present example, the second sleep period is interrupted by the manual actuation of the overcap 10, whereupon fluid is dispensed during a third spraying period. Automatic operation thereafter continues with alternating sleep and spraying periods. At any time during a sleep period, the user can manually actuate the overcap 10 for a selectable or fixed period of time by depressing the flange 86. Upon termination of the manual spraying operation, the overcap 10 completes the pending sleep period. Thereafter, a spraying operation is undertaken. In an alternative embodiment, a new sleep period is initiated in response to the termination of a manual spraying operation.

In another embodiment, the switch assembly 214 may be replaced or supplemented by a photocell sensor. The photocell sensor is used to detect changes in light levels, which in some instances is used to detect motion of an object through a sensory path. During use the photocell sensor collects ambient light and allows the circuit to detect any changes in the intensity thereof. Filtering of the photocell output is undertaken by the control circuit 210. If the control circuit 210 determines that a threshold light condition has been reached, e.g., a predetermined level of change in light intensity, the circuit 210 develops a signal to activate the solenoid valve assembly 240. For example, if the overcap 10 is placed in a lit bathroom, a person walking past the sensor may block a sufficient amount of ambient light from reaching the sensor to cause the control circuit 210 to activate the solenoid valve assembly 240 and discharge a fluid. Other motion detectors known to those of skill in the art may also be utilized e.g., a passive infrared or pyro-electric motion sensor, an infrared reflective motion sensor, an ultrasonic motion sensor, or a radar or microwave radio motion sensor.

It is also envisioned that the switch assembly 214 may be replaced or supplemented with a vibration sensor, an odor sensor, a heat sensor, or any other sensor known to those skilled in the art. Alternatively, more than one sensor may be provided in the overcap 10 in lieu of the switch assembly 214 or in combination with same. It is anticipated that one skilled in the art may provide any type of sensor either alone or in combination with the switch assembly 214 and/or other sensors to meet the needs of a user. In one particular embodiment, the switch assembly 214 and a sensor are provided in the same overcap. In such an embodiment, a user may choose to use the timer-based switch assembly 214 to automatically operate the solenoid valve assembly 240 of the overcap 10, or the user may choose to use the sensor to detect a given event prior to activating the overcap 10. Alternatively, the overcap 10 may operate in a timer and sensor based mode of operation concurrently.

The LED 220 illuminates the light transmissive rod 144 when the overcap 10 is in an operative state. The LED 220 blinks intermittently once every fifteen seconds during the sleep period. Depending on the selected operating mode, the blinking frequency of the LED 220 begins to increase as a spraying period becomes imminent. The more frequent illumination of the LED 220 serves as a visual indication that the overcap 10 is about to discharge fluid contents into the atmosphere.

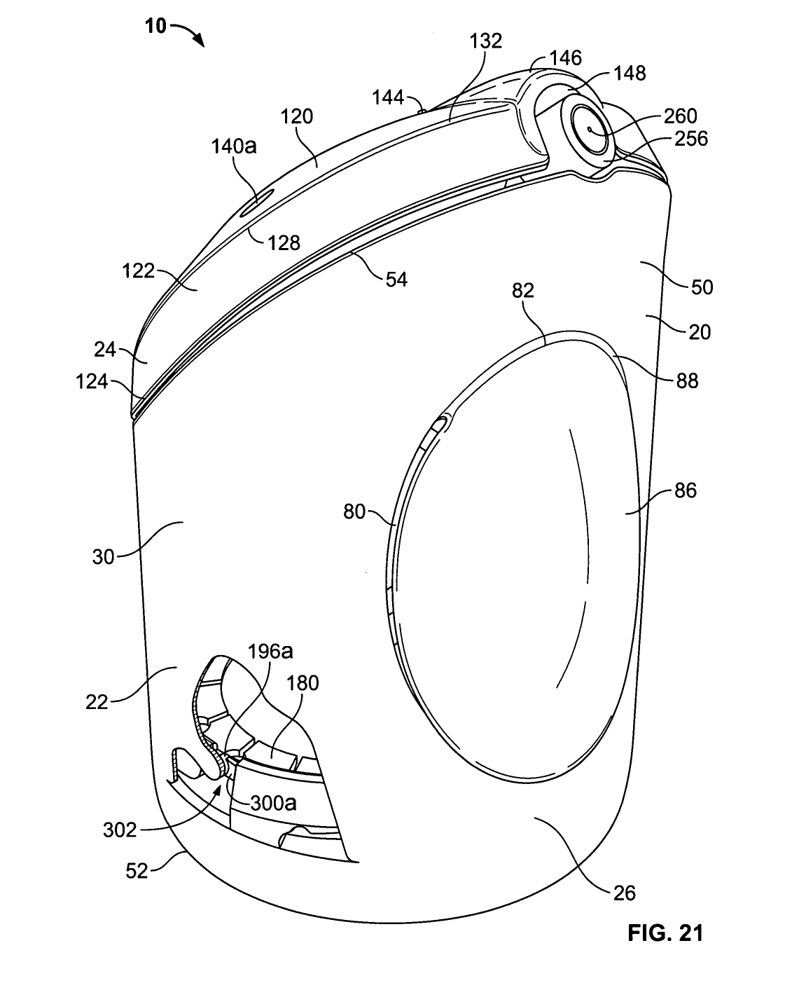

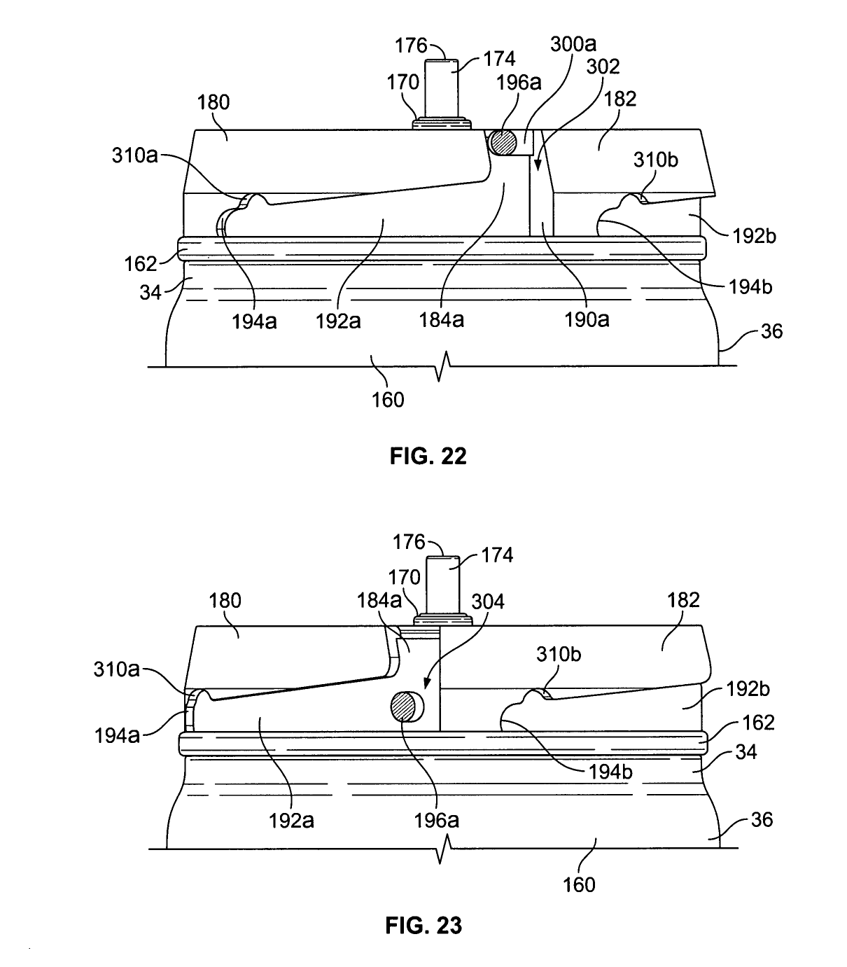

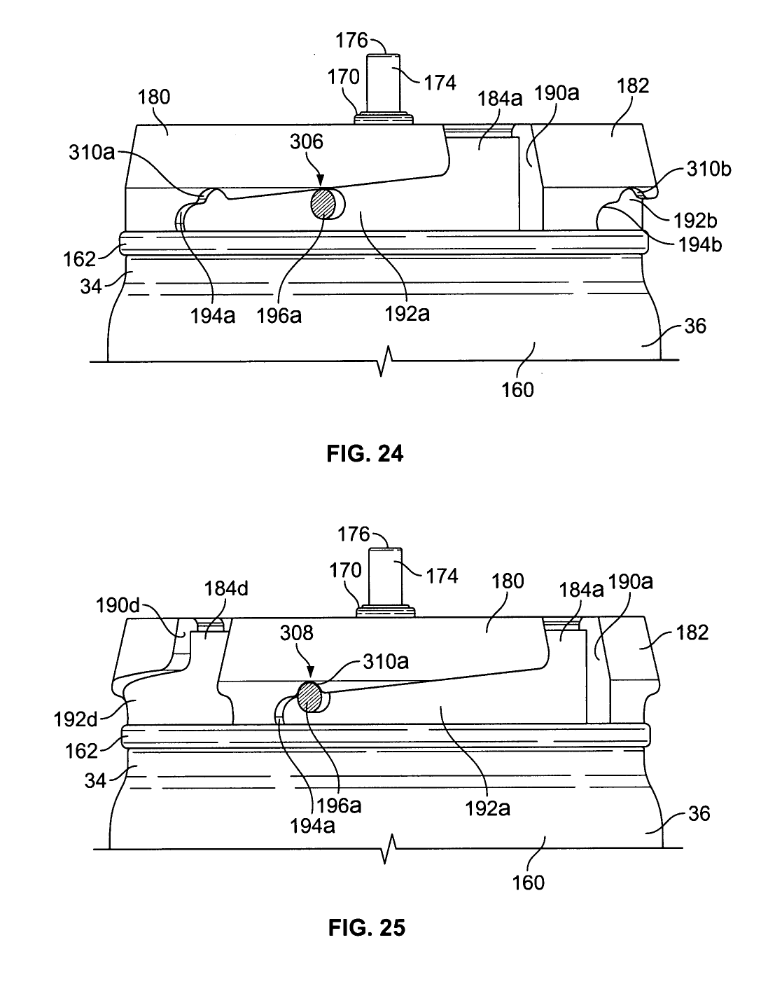

FIGS. 21-25 illustrate a second manner in which the overcap 10 is operably placed on the container 36. In the present embodiment, the lugs 196a-d are retained within the bayonet slots 184a-d by corresponding frangible tabs. To illustrate how the overcap 10 is placed in an operative position, reference will be had to the lug 196a and how same is transitioned from a pre-operative position to a post-operative position. FIG. 21 illustrates how the lug 196a extends inwardly from the inner surface 198 of the body portion 22 and is connected to the bracket 180 by a frangible tab 300a in a first or pre-operative position 302. FIG. 22 more clearly illustrates the positioning of the lug 196a in this pre-operative position 302 by the removal of portions of the overcap 10. When a user wishes to place the overcap 10 in an operative position, the user forces the overcap 10 downwardly about the longitudinal axis 56 toward the container 36. Forcing the overcap 10 downwardly causes the frangible tab 300a to break and for the lug 196a to be forced downwardly within the groove 190a and into a second position 304, such as shown in FIG. 23. The user thereafter rotates the overcap 10 in a clockwise direction to force the lug 196a to pass through the channel 192a. FIG. 24 illustrates the lug 196a in a third position 306 within the channel 192a and interacting with the downwardly sloping walls that define the channel 192a. Continued rotational movement causes the lug 196a to force the overcap 10 downwardly with respect to the container 36 and into an operative position 308, such as illustrated in FIG. 25. The lug 196a is placed in the operative position 308 by causing the lug 196a to enter and be retained within a notch 310a. The lug 196a is retained within the notch 310a by the forces exerted by the valve spring of the valve assembly, i.e., as the overcap 10 is forced downwardly onto the container 36 the distal end 176 of the valve stem 174 resistively interacts with the second end 250 of the conduit 246 to try to push the overcap 10 away from the container 36. Therefore, the force that was previously overcome during the downward and rotational movements illustrated in FIGS. 23 and 24 now forces the lug 196a upwardly within the channel 192a and into the notch 310a, thereby retaining the lug 196a in the notch 310a and the overcap 10 in the operative position 308. Likewise, the lugs 196b, 196c, 196d are placed in an operative position in a similar manner and include corresponding frangible portions and notches 310b, 310c, 310d, respectively (see FIG. 17). The presently described embodiments may also be particularly advantageous when it is desired to package and/or transport the overcap 10 in combination with the container 36 while preventing the inadvertent dispensing of fluid.

In any of the embodiments described herein, the bracket 180 may be affixed to a container prior to receipt by a user. Alternatively, a user may place the bracket 180 on the container. Further, the bracket 180 may or may not be affixed to an overcap by a frangible portion. The use of a bracket in combination with an overcap may allow the reuse of the overcap with a replacement container and/or assist in preventing the inadvertent use of a container that may not work with a specific overcap. Such combinations have been referred to as lock and key mechanisms and have numerous advantages known to those of skill in the art. For example, the inadvertent use of the overcap 10 with a non-specified container may damage the overcap 10 or the container, which may require the user to replace one or more of the container and the overcap 10. It is also contemplated that the various embodiments of the bracket 180 described herein may be used in connection with other overcaps that include vertical or tilt activated valve stems. It is also anticipated that the various embodiments of the bracket 180 described herein may be used in connection with other overcaps having different actuation mechanisms than a valve assembly in combination with a vertically activated valve stem kept in a continuously open or partially open state, e.g., the actuation mechanism could be a drive unit that comprises a solenoid, a bimetallic actuator, a piezo-linear motor, or an electro-responsive wire that is adapted to actuate a vertical or tilt-activated valve stem. For example, it is anticipated that the bracket 180 may be combined with any of the overcaps described in a U.S. Patent Application entitled Actuator Cap for a Spray Device, filed on May 10, 2007, with a docket number of J-4462, which is incorporated by reference herein in its entirety.

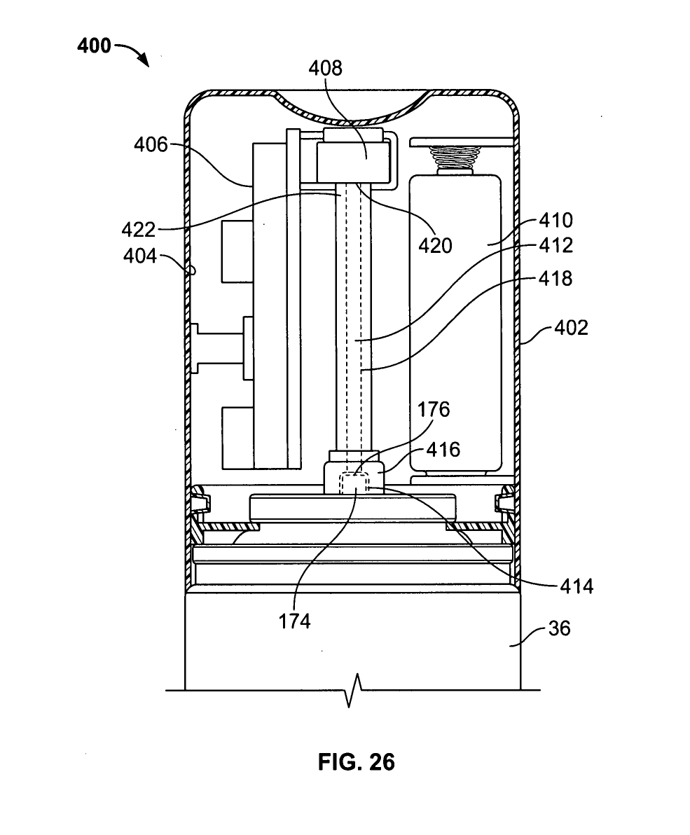

FIG. 26 depicts another embodiment of an overcap 400. The present embodiment comprises a cylindrical sidewall 402 having an inner surface 404. A control circuit 406 is mounted on the inner surface 404 and is in electrical communication with a two-way solenoid valve assembly 408. The solenoid valve assembly 408 and the control circuit 406 are also in electrical communication with a power source, such as two double AA batteries 410, which are similarly retained on the inner surface 404 of the overcap 400. A dispensing member 412, which in the present embodiment comprises a tubular element, is provided within an interior of the overcap 400 between the control circuit 406 and the batteries 410. When the overcap 400 is placed on the container 36, the distal end 176 of the valve stem 174 is seated within a circular opening 414 adjacent a bottom end 416 of the dispensing member 412. A bore 418 extends from the opening 414 and through a discharge orifice 420 in a top end 422 of the dispensing member 412. The solenoid valve assembly 408 is in fluid communication with the top end 422 of the dispensing member 412. When the overcap 400 is secured to the container 36 the dispensing member 412 interacts with the valve stem 174 to hold same in an open position. The emission of fluid from the overcap 400 is thereafter controlled by the circuit 406 and the solenoid valve assembly 408 in a similar manner as described above.

In some embodiments, the overcap 10 may be modified to provide an engagement mechanism that prevents inadvertent use of the overcap 10 with non-specified containers. The use of such lock and key mechanisms has numerous advantages known to those of skill in the art. For example, the inadvertent use of the overcap 10 with a non-specified container may damage the overcap 10 or the container, which may require the user to replace one or more of the container and the overcap 10. The engagement mechanism can also assist in preventing the mixture of different aerosolized products that may react with one another. For example, when a first aerosol container with a first product is replaced by a second aerosol container with a second product, residual amounts of the first product may still reside within the actuator cap 10 which could mix with the second product to produce an undesired effect. Further, engagement mechanisms may also provide assistance in the alignment of the valve stem 174 with the second end 250 of the conduit 246. While various engagement mechanisms are known to those of skill in the art, the engagement mechanisms described in U.S. Pat. No. 6,830,164 and U.S. Pat. No. 6,978,914, which are herein incorporated by reference in their entirety, are of particular interest.

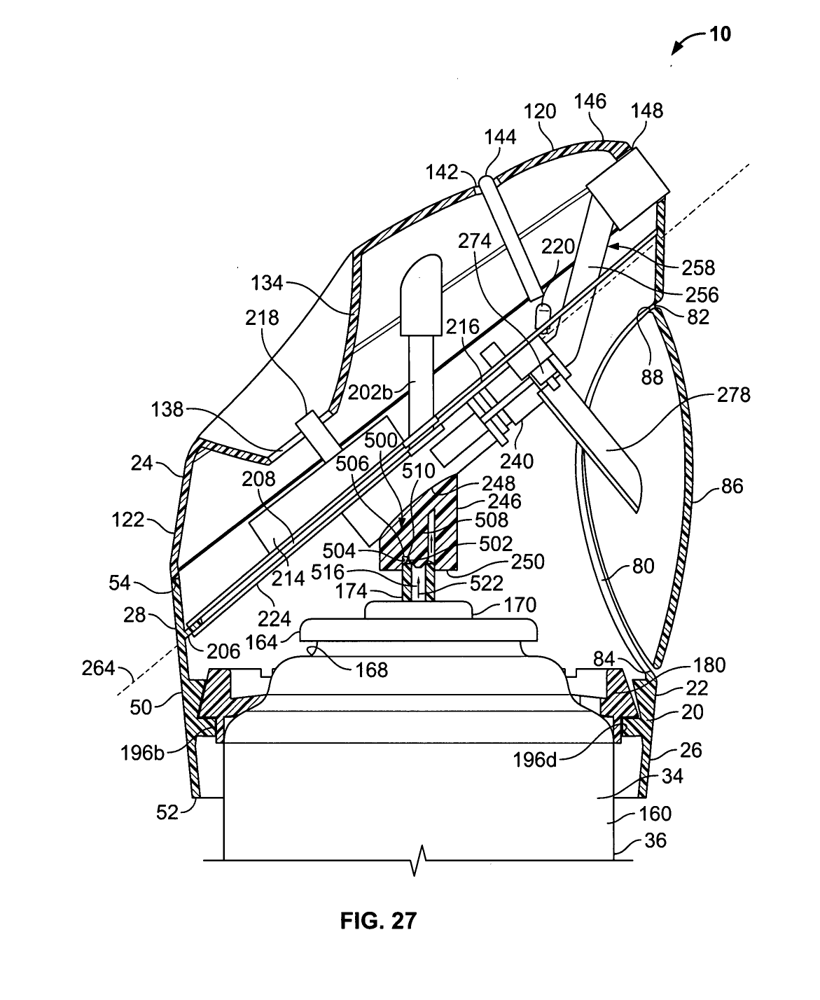

FIGS. 27-29 depict one embodiment of an engagement mechanism 500 for use with the overcap 10. The conduit 246 of the present embodiment is provided with an engagement groove 502 adjacent the second end 250 of the conduit 246. The engagement groove 502 is defined by a circumferential wall 504, an upper wall 506, and a downwardly projecting engagement member 508. The circumferential wall 504 maintains a fluid seal between an outer surface of the valve stem 174, which may be uniform in cross-section or may have a reduced diameter at an upper end thereof. The engagement member 508 includes a cylindrical member 510 having a tapered end. The tapered end of the cylindrical member 510 is adapted to sealingly engage with an inner peripheral surface 514 of the valve stem 174, which defines a geometric opening inconsistent with the sealing capability of the engagement member 508, such as a relatively square-like opening shown in FIGS. 27-29. Therefore, in the present embodiment, the engagement mechanism 500 is adapted to prevent fluid discharge from an aerosol container having a valve stem with a circular discharge orifice. For example, when the overcap 10 is mounted to an aerosol container with a valve stem having a circular discharge orifice, the cylindrical member 510 engages with portions of the valve stem defining a corresponding circular discharge orifice and forms a seal therewith. During a dispensing operation, no (or substantially no) fluid will be discharged from the container when the valve stem 174 is depressed by the engagement member 508 because fluid flow is significantly obstructed.

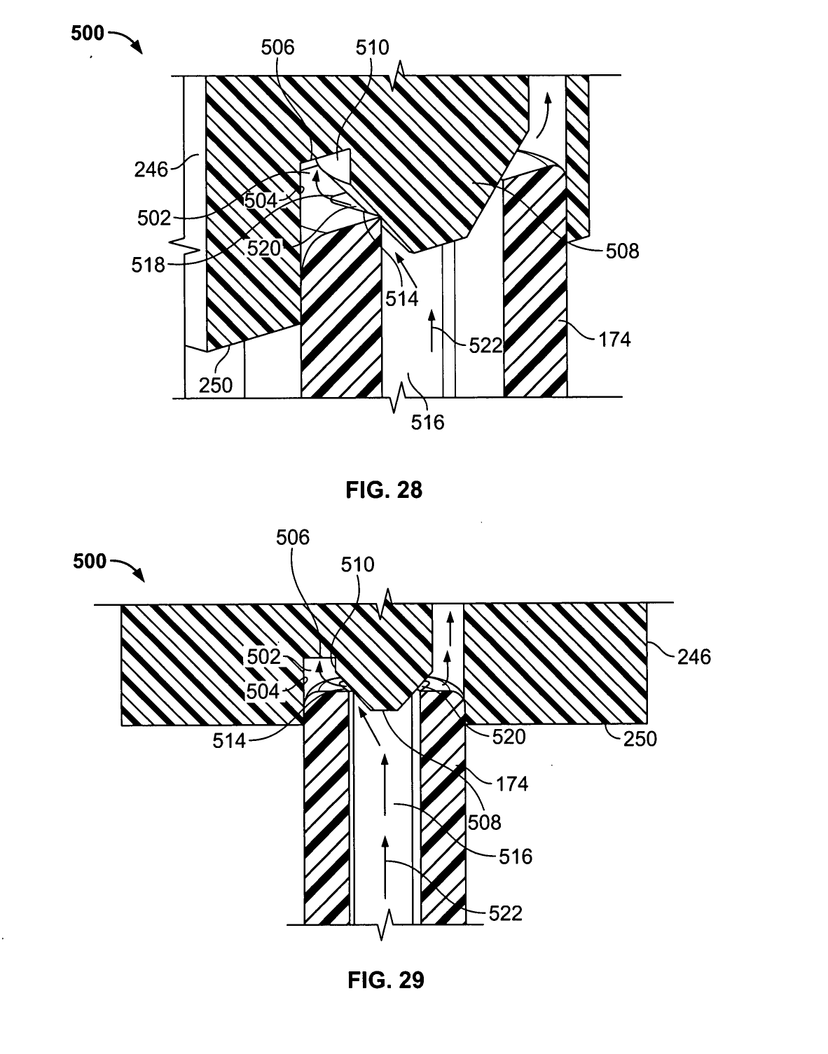

Turning again to FIGS. 28 and 29, the engagement mechanism 500 is shown in an operable position, i.e., the overcap 10, which has been removed for purposes of clarity, is mounted on the container 36 and the valve stem 174 is depressed by the engagement member 508. A flow channel 516 extends axially through a length of the valve stem 174 to a discharge orifice having a geometric opening inconsistent with the sealing capability of the engagement member 508. In the present embodiment, the flow channel 516 extends to a substantially square discharge orifice 518 defined by the inner peripheral surface 514. Further, in the present embodiment the engagement member 508 and the inner peripheral surface 514 define four clearances 520 through which fluid flows. Arrows 522 generally delineate a path that the aerosolized fluid traverses, which extends from the flow channel 516, through the clearances 520, into the engagement groove 502, and subsequently through the conduit 246 where the fluid enters the solenoid valve assembly 240. As indicated above, it is also contemplated that the flow channel 516 and/or the discharge orifice 518 may be modified to take on any shape and/or size so long as the corresponding engagement member has a different shape and/or size to allow for clearance to exist therebetween. It is further contemplated that the discharge orifice 518 of the valve stem 174 or the inner peripheral surface 514 may be contoured, i.e, provided with concave, convex, or other shaped surfaces, so long as a sealing surface of the engagement member 508 maintains an effective seal with conventional valve stems having circular discharge orifices. Further, the cylindrical member 510 defining the engagement member 508 may be truncated at a distal end thereof, provided with a conical distal end, or shaped in any manner desired insofar as effective fluid communication is maintained between the flow channel 516 and the clearances 520.

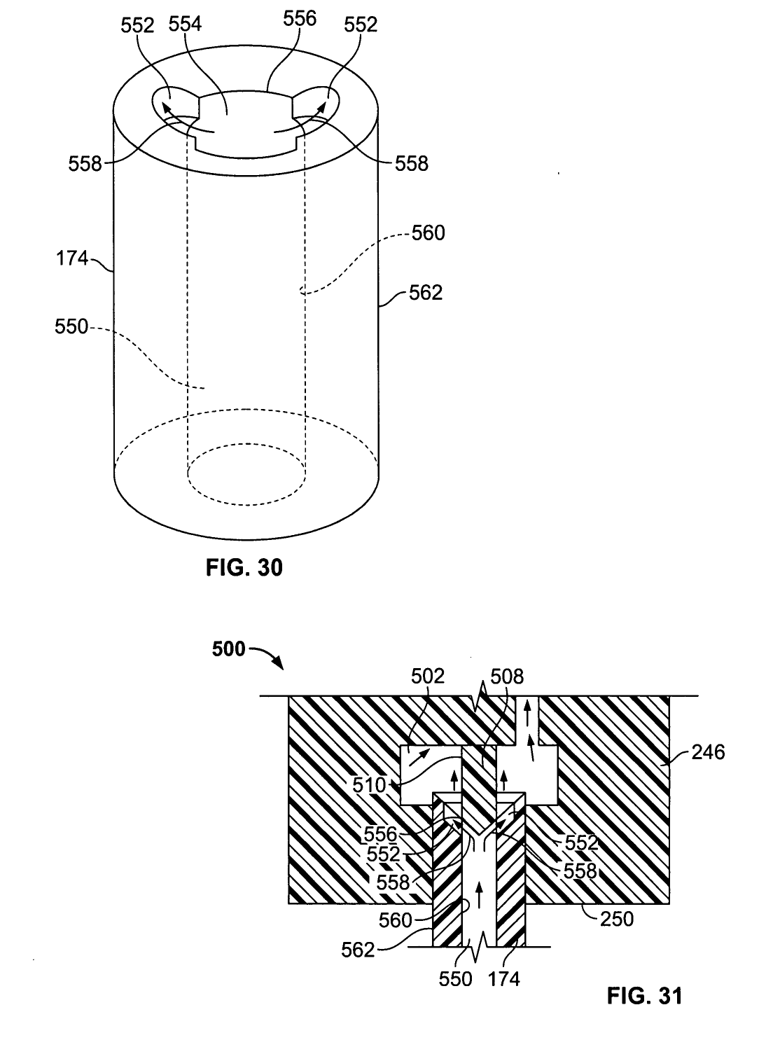

It is anticipated that the engagement mechanism 500 may also be used with various other modified valve stems. FIGS. 30 and 31 depict a flow channel 550 that extends axially through a length of the valve stem 174. The flow channel 550 is in fluid communication with one or more secondary channels or grooves 552. The grooves 552 extend upwardly to a discharge orifice 554 of the valve stem 174. The discharge orifice is defined by an inner peripheral surface 556 having a generally non-circular shape because of the grooves 552. Depression of the valve stem 174 by the engagement member 508 causes portions thereof to engage with portions of the inner peripheral surface 556 that are not co-extensive with the grooves 552. Arrows 558 similarly delineate a general path that the aerosolized fluid traverses, which extends from the flow channel 550, through the grooves 552, into the engagement groove 502, and subsequently through the conduit 246 where the fluid enters the solenoid valve assembly 240. In a different embodiment the number and/or shape of the grooves 552 can be modified. In another embodiment, one or more channels (not shown) may extend from an inner surface 560 of the valve stem 174 that defines the flow channel 550 to an exterior surface 562 thereof.

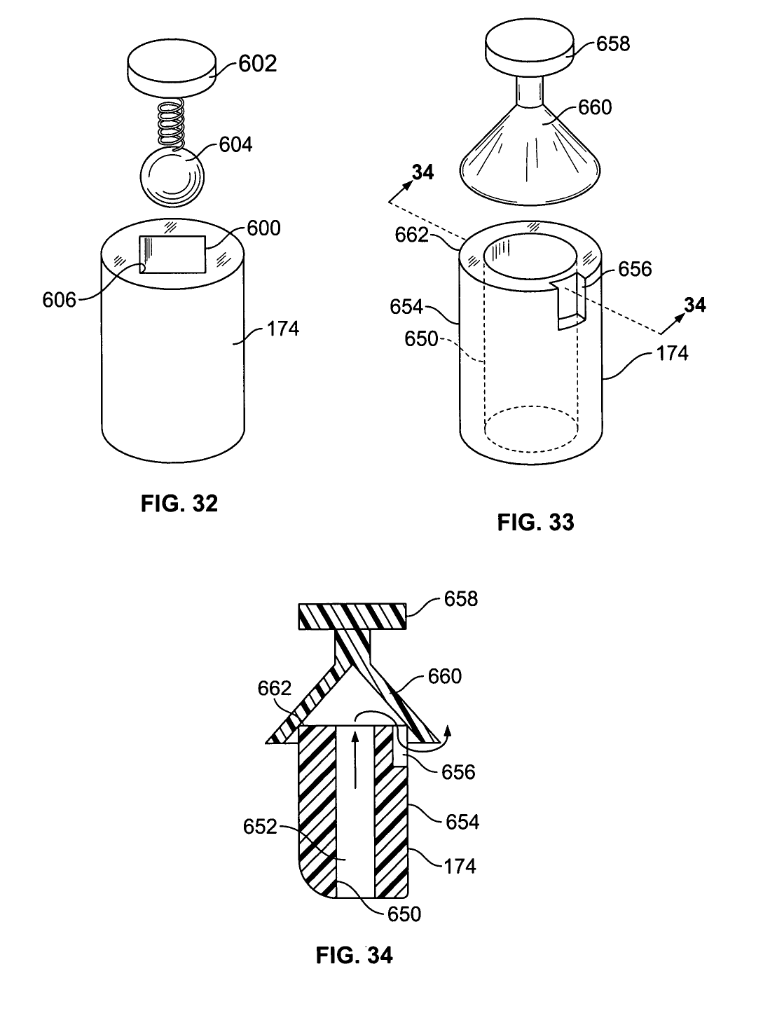

It is also anticipated that numerous other engagement mechanisms can be employed with the embodiments described herein. For example, FIG. 32 depicts the valve stem 174 having a square axial passage 600. An engagement member 602 is provided that includes a spherical spring-biased ball 604. When the ball 604 and the valve stem 174 are engaged during a dispensing sequence, the ball 604 is at least partially disposed within the axial passage 600. Fluid ejected through the valve stem 174 may pass through one or more clearances 606 provided about the periphery of the axial passage 600, wherein the clearances 606 are formed when the ball 604 is engaged with the valve stem 174. If a conventional valve stem with a circular discharge orifice were to be engaged with the ball 604, there would be no (or substantially no) clearance for the emission of the fluid. The square axial passage 600 may be modified to take on any shape and/or size so long as the corresponding engagement member has a different shape and/or size to allow for clearance to exist therebetween.

FIGS. 33 and 34 depict yet another embodiment of the valve stem 174 that includes an interior surface 650 defining a first channel 652 and an exterior surface 654 that includes a side opening or a second channel 656 disposed therein. An actuation member 658 includes a hollow engagement member 660, which has a generally inverted frusto-conical shape for sealing engagement with a peripheral surface 662 of the valve stem 174. When the valve stem 174 and the engagement member 660 are engaged during a dispensing sequence, the fluid first flows in the direction of the arrow upwardly through the first channel 652 and thereafter downwardly through the second channel 656. If a conventional valve stem with a circular discharge orifice were utilized with the present embodiment, the fluid will be trapped within the engagement member 660 and no (or substantially no) fluid will be discharged from the overcap 10.

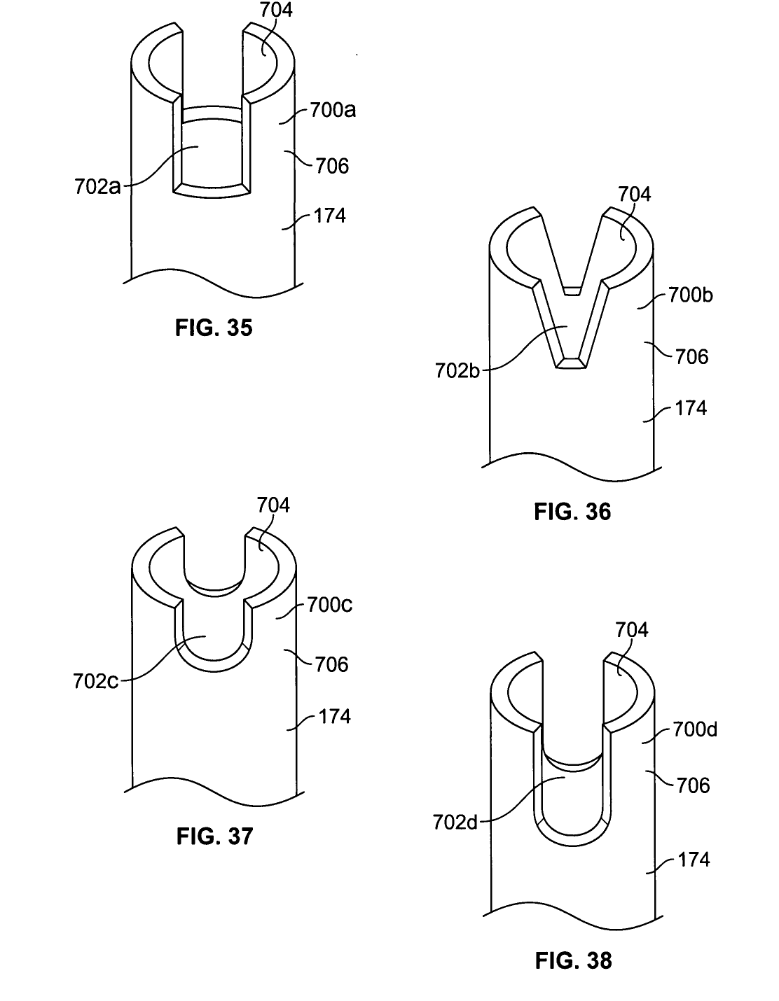

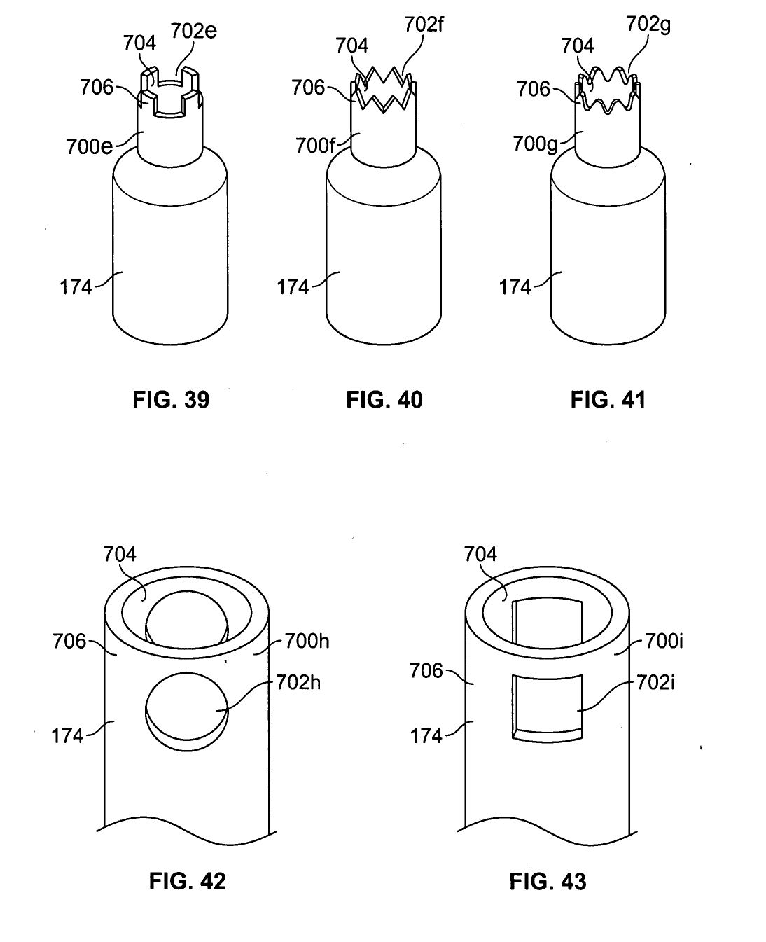

In a different embodiment, the valve stem 174 is modified to include the structure shown in any of FIGS. 35-43. All of the modified valve stems include exterior ends 700a-i and at least one side opening 702a-i, respectively, wherein some of the exterior ends 700a-i are depicted with reduced diameters to illustrate how any of the valve stems disclosed herein may be modified. The side opening 702a-i extends from an interior axial chamber 704 of the valve stem 174 through an outer wall 706 thereof. The presently described valve stems 174 may be used in conjunction with the embodiments described above, e.g., the engagement mechanism 500, or they may be used in conjunction with a modified version of a dispenser inlet valve that is described in connection with FIGS. 25-34 of U.S. Pat. No. 6,978,914. It is intended that the structure disclosed with respect to the dispenser inlet valve in U.S. Pat. No. 6,978,914 be modified to be incorporated fully or partially into the conduit 246 of the various embodiments disclosed herein. The various arrangements described above will prevent emission of the contents of a container, which does not include a valve stem with at least one side opening that extends fully (see for example FIGS. 35-43) or partially (see for example FIGS. 33 and 34) through a wall of the valve stem.

The embodiments described herein are illustrative of some of the different ways that a valve stem of an aerosol container may be held in an open condition to supply fluid to a two-way solenoid valve assembly. It will be apparent that numerous aspects of the embodiments described herein may be modified, such as the size and orientation of the nozzle 256 or the dispensing member 412. For example, the dispensing member 412 in the overcap 400 is substantially parallel to a longitudinal axis 56 of the overcap 10 and of the container 36, but may be easily modified to extend at a different angle relative to either of the axes. In a different example, the nozzle 256 and/or the discharge end 260 may comprise a non-cylindrical shape and/or include varying cross-sectional dimensions throughout an entire or partial length thereof. Further, in a different example the discharge orifice 262 and/or the conduit or bore extending thereto may include a non-circular shape in whole or in part. Still further, it is anticipated that the conduit 246 and the valve stem 174 may be modified accordingly to carry out any of the disclosed engagement mechanisms. It is also anticipated that a non-aerosol container having a valve stem may be used in connection with any of the embodiments disclosed herein.

### INDUSTRIAL APPLICABILITY

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

I/We claim:

1. An actuator cap for a container, comprising:
a housing having first and second ends, wherein the first end is adapted to be retained on a container having a valve stem;
a conduit having first and second ends, wherein an engagement member is provided within the conduit adjacent the second end thereof, and wherein the engagement member is adapted to prevent fluid discharge from a valve stem having a circular discharge orifice and allow fluid discharge from a valve stem having a non-circular discharge orifice; and
a solenoid valve in fluid communication with the first end of the conduit and a discharge nozzle of the housing.

2. The actuator cap of claim 1, wherein the housing is disposed on a container.

3. The actuator cap of claim 1, wherein the housing is adapted to be removably attached to the container.

4. The actuator cap of claim 1, wherein the solenoid valve is transitioned from a closed state to an open state by a signal generated by a controller to provide a fluid path between the conduit and the discharge nozzle.

5. The actuator cap of claim 4, wherein the controller is further adapted to generate a signal in response to a timer.

6. The actuator cap of claim 4, wherein the controller is further adapted to generate a signal in response to a sensor.

7. The actuator cap of claim 1, wherein the engagement member is a cylindrical member having a tapered end defining a sealing surface.

8. An overcap for a container, comprising:
a housing having a bottom end and a top end, wherein the bottom end is adapted to be retained on a container having a valve stem;
a conduit having first and second ends, wherein an engagement member is provided within the conduit adjacent the second end thereof, and wherein the engagement member is adapted to prevent fluid discharge from a valve stem having a uniformly circular discharge orifice and allow fluid discharge from a valve stem having at least one side opening therethrough; and
a solenoid valve in fluid communication with the first end of the conduit and a discharge nozzle of the housing.

9. The overcap of claim 8, wherein the housing is disposed on a container.

10. The overcap of claim 8, wherein the engagement member is adapted to retain a valve stem in fluid communication with the conduit.

11. The overcap of claim 8, wherein the engagement member is adapted to guide a valve stem into fluid communication with the conduit.

12. The overcap of claim 8, wherein the solenoid valve is transitioned from a closed state to an open state by a signal generated by a controller to provide a fluid path between the conduit and the discharge nozzle.

13. The overcap of claim 12, wherein the controller is further adapted to generate a signal in response to a timer.

14. The overcap of claim 12, wherein the controller is further adapted to generate a signal in response to a sensor.

15. A method for preventing incorrect refill of a dispensing system, comprising:
providing a housing having first and second ends, wherein the first end is adapted to be retained on a container having a valve stem;
providing a conduit having first and second ends, wherein an engagement member is provided within the conduit adjacent the second end thereof, and wherein the engagement member is adapted to prevent fluid discharge from a valve stem having a circular discharge orifice and allow fluid discharge from a valve stem having a non-circular discharge orifice; and
providing a solenoid valve in fluid communication with the first end of the conduit and a discharge nozzle of the housing.

16. The method of claim 15, wherein the housing is disposed on a container.

17. The method of claim 16, wherein housing is adapted to be removably attached to the container.

18. The method of claim 16, wherein the solenoid valve is transitioned from a closed state to an open state by a signal generated by a controller to provide a fluid path between the conduit and the discharge nozzle.

19. The method of claim 18, wherein the controller is adapted to generate a signal in response to a sensor.

20. The method of claim 18, wherein the controller is adapted to generate a signal in response to a timer.
